(19) United States
(12) Patent Application Publication
(10) Pub. No.: US 2024/0073428 A1
(43) Pub. Date: Feb. 29, 2024

(54) INTRA PREDICTION FOR ASYMMETRIC PARTITION

(71) Applicant: InterDigital CE Patent Holdings , SAS, Paris (FR)

(72) Inventors: Gagan Bihari Rath, Rennes (FR); Fabrice Le Leannec, Betton (FR); Karam Naser, Mouazé (FR); Ya Chen, Rennes (FR)

(21) Appl. No.: 18/039,677

(22) PCT Filed: Nov. 23, 2021
(86) PCT No.: PCT/EP2021/082680

§ 371 Date: May 31, 2023

(30) Foreign Application Priority Data
Dec. 3, 2020 (EP) 20306490.2
Dec. 3, 2020 (EP) 20306492.8

(51) Int. Cl. H04N 19/159; H04N 19/176; H04N 19/70

(52) U.S. Cl. CPC H04N 19/159; H04N 19/176; H04N 19/70

(57) ABSTRACT

At least a method and an apparatus are presented for efficiently encoding or decoding video. For example, the encoding or decoding comprises determining an intra prediction mode from a set of regular angular intra prediction modes and wide angular intra prediction modes wherein at least one of an angle or a reference array used by the angular intra prediction mode in the set are adapted to the width or the height of the image block which is not power of two. For example, the encoding or decoding comprises determining an intra sub-partition mode for an image block wherein at least one of a size or a number of intra sub-partitions in an intra sub-partition mode are adapted to the width or the height of the image block which is not power of two. Various embodiments are described for a ratio r used in an asymmetric split and p intra sub-partitions.

### TECHNICAL FIELD

At least one of the present embodiments generally relates to a method or an apparatus for video encoding or decoding, and more particularly, to a method or an apparatus adapting intra prediction to a width or a height of an image block which is not power of two.

At least one embodiment more particularly relates to a method or an apparatus adapting at least one of an angle of an angular intra prediction mode or a reference array used by the angular intra prediction mode to a width or a height of an image block which is not power of two.

At least one embodiment more particularly relates to a method or an apparatus adapting at least one of a size of an intra sub-partition or a number of intra sub-partitions to a width or a height of an image block which is not power of two.

### BACKGROUND

To achieve high compression efficiency, image and video coding schemes usually employ prediction, including motion vector prediction, and transform to leverage spatial and temporal redundancy in the video content. Generally, intra or inter prediction is used to exploit the intra or inter frame correlation, then the differences between the original image and the predicted image, often denoted as prediction errors or prediction residuals, are transformed, quantized, and entropy coded. To reconstruct the video, the compressed data are decoded by inverse processes corresponding to the entropy coding, quantization, transform, and prediction.

Recent additions to video compression technology include various industry standards, versions of the reference software and/or documentations such as Joint Exploration Model (JEM) and later VTM (Versatile Video Coding (VVC) Test Model) being developed by the JVET (Joint Video Exploration Team) group. The aim is to make further improvements to the existing HEVC (High Efficiency Video Coding) standard.

Existing methods for coding and decoding show some limitations on intra prediction in the case of asymmetric partitioning resulting into rectangular block whose width or height is not a power of two.

More particularly, existing methods for coding and decoding show some limitations on the size of rectangular block in wide angular intra prediction. Therefore, there is a need to improve the state of the art by improving the wide angle intra prediction in VVC so that it can also be used in the case of asymmetric partitioning resulting into rectangular block whose width or height is not a power of two (called non-dyadic block), as for instance in asymmetric binary tree (ABT) or asymmetric triple tree partitioning.

More particularly, existing methods for coding and decoding show some limitations on the size of partitions in intra sub-partition prediction, the partition is supposed to having its width and height equal to powers of 2. Therefore, there is a need to improve the state of the art by modifying the intra-sub partition in VVC so that it can also be used in the case of asymmetric partitioning resulting into rectangular block whose width or height is not a power of two (called non-dyadic block), as for instance in asymmetric binary tree (ABT) or asymmetric triple tree partitioning

### SUMMARY

The drawbacks and disadvantages of the prior art are solved and addressed by the general aspects described herein.

According to a first aspect, there is provided a method. The method comprises video decoding by determining an intra prediction mode for the image block, wherein at least one of a width or a height of the image block is not power of two; and wherein at least one configuration of an intra prediction mode is adapted to the width or the height of the image block which is not power of two; and decoding the block using the determined intra prediction mode.

According to another aspect, there is provided a method. The method comprises video encoding by determining an intra prediction mode for the image block, wherein at least one of a width or a height of the image block is not power of two; and wherein at least one configuration of an intra prediction mode is adapted to the width or the height of the image block which is not power of two; and encoding the block using the determined intra prediction mode.

According to another aspect, there is provided a method. The method comprises video decoding by determining an intra prediction mode from a set of regular angular intra prediction modes and wide angular intra prediction modes for the image block, wherein at least one of a width or a height of the image block is not power of two, wherein at least one of an angle of an angular intra prediction mode in the set or a reference array used by the angular intra prediction mode in the set are adapted to the width or the height of the image block which is not power of two; and decoding the block using the determined intra prediction mode.

According to another aspect, there is provided another method. The method comprises video encoding by determining an intra prediction mode from a set of regular angular intra prediction modes and wide angular intra prediction modes for the image block, wherein at least one of a width or a height of the image block is not power of two, wherein at least one of an angle of an angular intra prediction mode in the set or a reference array used by the angular intra prediction mode in the set are adapted to the width or the height of the image block which is not power of two; and encoding the block using the determined intra prediction mode.

According to another aspect, there is provided an apparatus. The apparatus comprises one or more processors, wherein the one or more processors are configured to implement the method for video decoding according to any of its variants. According to another aspect, the apparatus for video decoding comprises means for determining an intra prediction mode from a set of regular angular intra prediction modes and wide angular intra prediction modes for the image block, wherein at least one of a width or a height of the image block is not power of two, wherein at least one of an angle of an angular intra prediction mode in the set or a reference array used by the angular intra prediction mode in the set are adapted to the width or the height of the image block which is not power of two; and wherein the apparatus further comprises means for decoding the block using the determined intra prediction mode.

According to another aspect, there is provided another apparatus. The apparatus comprises one or more processors, wherein the one or more processors are configured to implement the method for video decoding according to any of its variants. According to another aspect, the apparatus for video decoding comprises means for determining an intra prediction mode from a set of regular angular intra prediction modes and wide angular intra prediction modes for the image block, wherein at least one of a width or a height of the image block is not power of two, wherein at least one of an angle of an angular intra prediction mode in the set or a reference array used by the angular intra prediction mode in the set are adapted to the width or the height of the image block which is not power of two; and wherein the apparatus further comprises means for encoding the block using the determined intra prediction mode.

According to another general aspect of at least one embodiment, wherein the width W and the height H of the image block are not equal.

According to another general aspect of at least one embodiment, wherein the width of the image block is W=w and the height of the image block is H=rh or the width of the image block is W=rw and the height H=h of the image block is where h and w are powers of two and where r is a positive rational number less than 1 such that rh or rw is a positive integer different from a power of 2. In different variants r=3/4, or 3/8, 5/8.

According to another general aspect of at least one embodiment, wherein only regular angular intra prediction modes are allowed and a reference array used in intra prediction is extended to a size equal to H+W+1.

According to another general aspect of at least one embodiment, wherein two only wide angular intra prediction modes are allowed and a reference array used in intra prediction is extended to a size equal to 2H+p or 2W+p where p=1, 2 or 4 depending of the width W and the height H of the image block.

According to another general aspect of at least one embodiment, wherein an angle value of at least one regular angular intra prediction modes are modified and a reference array used in intra prediction is 2H+1 or 2W+1.

According to another general aspect of at least one embodiment, the variant method to apply for wide angular angle is derived from the availability of neighboring reconstructed samples for the reference array used in intra prediction.

According to another general aspect of at least one embodiment, wherein at least one syntax data element related to enabling any of variant methods to apply for wide angular angle is signaled in one of a slice, a Picture Parameter Set (PPS), a Sequence Parameter Set (SPS).

According to another aspect, there is provided a method. The method comprises video decoding by determining an intra sub-partition mode for an image block of the video; wherein one of a width or a height of the image block is not power of two; and wherein at least one of a size of an intra sub-partition or a number of intra sub-partitions in an intra sub-partition mode are adapted to the width or the height of the image block which is not power of two; and decoding the block using the determined intra sub-partition mode.

According to another aspect, there is provided another method. The method comprises video encoding by determining an intra sub-partition mode for an image block of the video; wherein one of a width or a height of the image block is not power of two; and wherein at least one of a size of an intra sub-partition or a number of intra sub-partitions in an intra sub-partition mode are adapted to the width or the height of the image block which is not power of two; and encoding the block using the determined intra sub-partition mode.

According to another aspect, there is provided an apparatus. The apparatus comprises one or more processors, wherein the one or more processors are configured to implement the method for video decoding according to any of its variants. According to another aspect, the apparatus for video decoding comprises means for determining an intra sub-partition mode for an image block of the video; wherein one of a width or a height of the image block is not power of two; and wherein at least one of a size of an intra sub-partition or a number of intra sub-partitions in an intra sub-partition mode are adapted to the width or the height of the image block which is not power of two; and wherein the apparatus for video decoding further comprises means for decoding the block using the determined intra sub-partition mode.

According to another aspect, there is provided another apparatus. The apparatus comprises one or more processors, wherein the one or more processors are configured to implement the method for video decoding according to any of its variants. According to another aspect, the apparatus for video decoding comprises means for determining an intra sub-partition mode for an image block of the video, wherein one of a width or a height of the image block is not power of two, and wherein at least one of a size of an intra sub-partition or a number of intra sub-partitions in an intra sub-partition mode are adapted to the width or the height of the image block which is not power of two; and wherein the apparatus for video encoding further comprises means for encoding the block using the determined intra sub-partition mode.

According to another general aspect of at least one embodiment, the width of the image block is w=W and the height of the image block is h=3H/4 or the width of the image block is w=3W/4 and the height of the image block is h=H where W and H are power of two. In a more generic embodiment, the width w of the image block is w=W and the height h of the image block is h=rH or the width of the image block is w=rW and the height is h=H of the image block, where h and w are power of two and where r is a positive rational number less than 1 such that rH or rW is a positive integer different from a power of 2. In a more generic embodiment, the ratio r is selected to lead to transform size supported by the encoding/decoding method or apparatus, i.e. with the implemented video codec design.

According to another general aspect of at least one embodiment, a horizontal intra sub-partition mode results into three sub-partitions of size W×H/4 for an image block of size W×3H/4. In a more generic embodiment, a horizontal intra sub-partition mode results into p sub-partitions of size

$$W \times \frac{r}{p} H$$

for an image block Or size W×rH, where r is a positive rational number less than 1, and p is a positive integer such that rH is a positive integer different from a power of 2, and

$$\frac{r}{p} H$$

corresponds to a transform size supported by the considered video codec.

According to another general aspect of at least one embodiment, a vertical intra sub-partition mode results into three sub-partitions of size W/4×H for an image block of size 3W/4×H. In a more generic embodiment, a vertical intra sub-partition mode results into p sub-partitions of size

$$\frac{r}{p} W \times H$$

for an image block of size rW×H, where r is a positive rational number less than 1, and p is a positive integer such that rW is a positive integer different from a power of 2, and

$$\frac{r}{p} W$$

corresponds to a transform size supported by the by the considered video codec.

According to another general aspect of at least one embodiment, a horizontal-up intra sub-partition mode results into two sub-partitions of size W×H/4 for the upper intra sub-partition and W×H/2 for the lower intra sub-partition for an image block of size W×3H/4 or a horizontal-down intra sub-partition mode results into two sub-partitions of size W×H/2 for the upper intra sub-partition and W×3H/4 for the lower intra sub-partition for an image block of size W×3H/4. In a more generic embodiment, a horizontal-up intra sub-partition mode results into two sub-partitions of size

$$W \times \frac{r}{p} H$$

for the upper intra sub-partition and

$$W \times ( r - \frac{r}{p} ) H$$

or the lower intra sub-partition for an image block of size W×rH, such that the transform sizes

$$\frac{r}{p} H and ( r - \frac{r}{p} ) H$$

are supported in the considered codec design, that is such that the transform sizes

$$\frac{r}{p} H and ( r - \frac{r}{p} ) H$$

are both equal to a power of 2.

According to another general aspect of at least one embodiment, a vertical-left intra sub-partition mode results into two sub-partitions of size of size W/4×H for the left intra sub-partition and W/4×H for the right intra sub-partition for an image block of size 3W/4×H or a vertical-right intra sub-partition mode results into two sub-partitions of size of size W/2×H for the left intra sub-partition and W/4×H for the right intra sub-partition for an image block of size 3W/4×H. In a more generic embodiment, a vertical-left intra sub-partition mode results into two sub-partitions of size

$$\frac{r}{p} W \times H$$

for the left intra sub-partition and

$$( r - \frac{r}{p} ) W \times H$$

for the right intra sub-partition for an image block of size rW×H, such that the transform sizes

$$\frac{r}{p} W and ( r - \frac{r}{p} ) W$$

are supported by the considered codec design.

According to another general aspect of at least one embodiment, one of a horizontal-up intra sub-partition mode or a horizontal-down intra sub-partition mode is used for an image block of size W×3H/4 and wherein one of a vertical-left intra sub-partition mode or a vertical-right intra sub-partition mode is used for an image block of size 3W/4×H. In a more generic embodiment, one of a horizontal-up intra sub-partition mode or a horizontal-down intra sub-partition mode is used for an image block of size W×rH and wherein one of a vertical-left intra sub-partition mode or a vertical-right intra sub-partition mode is used for an image block of size rW×H. According to another general aspect of at least one embodiment, the intra sub-partition mode is implicitly derived from the size of the image block and the asymmetric partitioning mode. According to another general aspect of at least one embodiment, at least one syntax data element related to enabling any of the disclosed instar sub-partition method is signaled in one of a slice, a Picture Parameter Set (PPS), a Sequence Parameter Set (SPS).

According to another general aspect of at least one embodiment, there is provided a device comprising an apparatus according to any of the decoding embodiments; and at least one of (i) an antenna configured to receive a signal, the signal including the video block, (ii) a band limiter configured to limit the received signal to a band of frequencies that includes the video block, or (iii) a display configured to display an output representative of the video block.

According to another general aspect of at least one embodiment, there is provided a non-transitory computer readable medium containing data content generated according to any of the described encoding embodiments or variants.

According to another general aspect of at least one embodiment, there is provided a signal comprising video data generated according to any of the described encoding embodiments or variants.

According to another general aspect of at least one embodiment, a bitstream is formatted to include data content generated according to any of the described encoding embodiments or variants.

According to another general aspect of at least one embodiment, there is provided a computer program product comprising instructions which, when the program is executed by a computer, cause the computer to carry out any of the described encoding/decoding embodiments or variants.

These and other aspects, features and advantages of the general aspects will become apparent from the following detailed description of exemplary embodiments, which is to be read in connection with the accompanying drawings.

### BRIEF DESCRIPTION OF THE DRAWINGS

In the drawings, examples of several embodiments are illustrated.

FIG. 1 illustrates the intra prediction modes according to VVC.

FIGS. 2a and 2b illustrate wide angle intra prediction for non-square blocks according to VVC.

FIG. 3 illustrates a quadtree (QT), binary tree (BT), and triple tree (TT) used in intra prediction partitioning according to VVC.

FIG. 4 illustrates an example of asymmetric binary tree (ABT) used in partitioning according a general aspect of at least one embodiment.

FIG. 5 illustrates a generic encoding method according to a general aspect of at least one embodiment.

FIG. 6 illustrates a generic decoding method according to a general aspect of at least one embodiment.

FIG. 7 illustrates a first variant of the wide angular mode adapted to non-dyadic CU according to a general aspect of at least one embodiment.

FIG. 8 illustrates a second variant of the wide angular mode to adapted non-dyadic CU according to a general aspect of at least one embodiment.

FIG. 9 illustrates a block diagram of an embodiment of video encoder in which various aspects of the embodiments may be implemented.

FIG. 10 illustrates a block diagram of an embodiment of video decoder in which various aspects of the embodiments may be implemented.

FIG. 11 illustrates a block diagram of an example apparatus in which various aspects of the embodiments may be implemented.

FIGS. 12 and 13 illustrate examples of intra sub partition according to VVC.

FIG. 14 illustrates a quadtree (QT), binary tree (BT), and triple tree (TT) used in intra prediction partitioning according to VVC.

FIG. 15 illustrates an example of asymmetric binary tree (ABT) used in partitioning according to a general aspect of at least one embodiment.

FIG. 16 illustrates a generic encoding method according to a general aspect of at least one embodiment.

FIG. 17 illustrates a generic decoding method according to a general aspect of at least one embodiment.

FIG. 18 illustrates a first variant of intra sub partition adapted to non-dyadic CU according to a general aspect of at least one embodiment.

FIG. 19 illustrates a second variant of intra sub partition adapted non-dyadic CU according to a general aspect of at least one embodiment.

FIGS. 20, 21, 22a and 22b illustrate other variants of intra sub partition adapted non-dyadic CU according to a general aspect of at least one embodiment.

FIG. 23 illustrates a generic encoding method according to a general aspect of at least one embodiment.

FIG. 24 illustrates a generic decoding method according to a general aspect of at least one embodiment.

### DETAILED DESCRIPTION

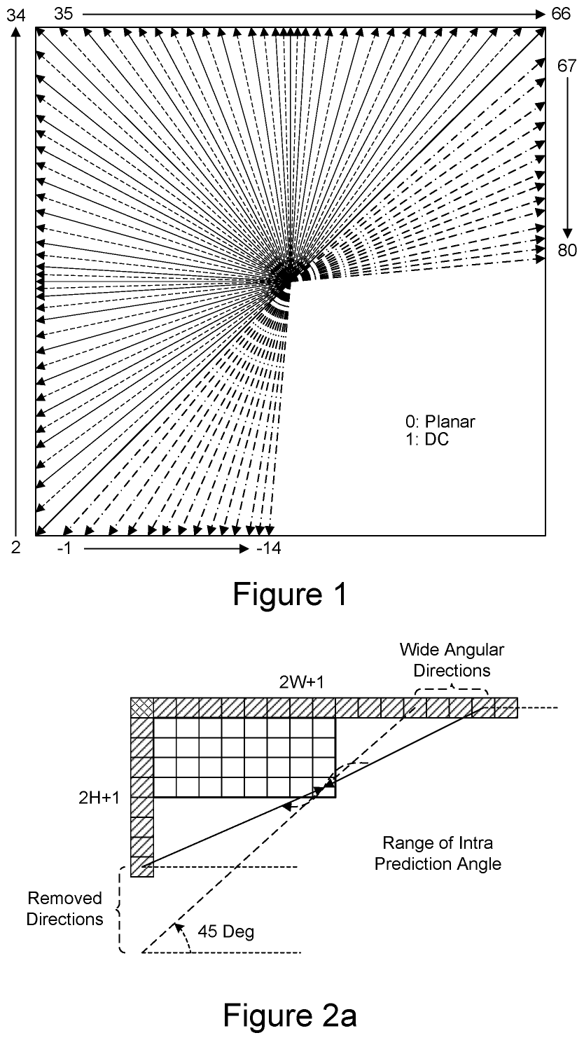

FIG. 1 illustrates the intra prediction modes in Versatile Video Coding (VVC). In VVC, intra prediction is applied in all blocks in Intra frames as well as in intra blocks in Inter frames, where a target block, called a coding unit (CU), is spatially predicted from the causal neighbor blocks in the same frame, i.e., the blocks on the top and top-right, the blocks on the left and left-bottom, and the top-left block. Based on the decoded pixel values in these blocks, the encoder constructs different predictions for the target block and chooses the one that leads to the best rate-distortion (RD) performance. The predictions are tested for 67 prediction modes, which include one PLANAR mode (indexed as mode 0), one DC mode (indexed as mode 1) and remaining 65 angular modes. The angular modes may include only the regular angular prediction modes from mode 2 to mode 66, or some wide angular modes defined beyond the angle range from 45 degrees to −135 degrees.

The wide angular prediction was introduced in to improve the prediction efficiency of rectangular CUs, that is, the CUs having unequal widths and heights. As VVC supports binary tree (BT) and triple tree (TT) partitions in addition to the quadtree (QT) partitions, which can result in rectangular CUs, wide angular prediction was shown to improve the compression performance at the same complexity level. The idea was to give preference to prediction directions in the longer side of a CU by checking with some wide angular directions on that side for RD performance, while avoiding equal number of regular angular modes which are likely to produce less accurate predictions. The new wide angular prediction directions were designed properly to adapt to different rectangular block shapes so that the defined prediction directions are always aligned over the secondary diagonal of a block (the diagonal extending from the bottom-left corner to the top-right corner).

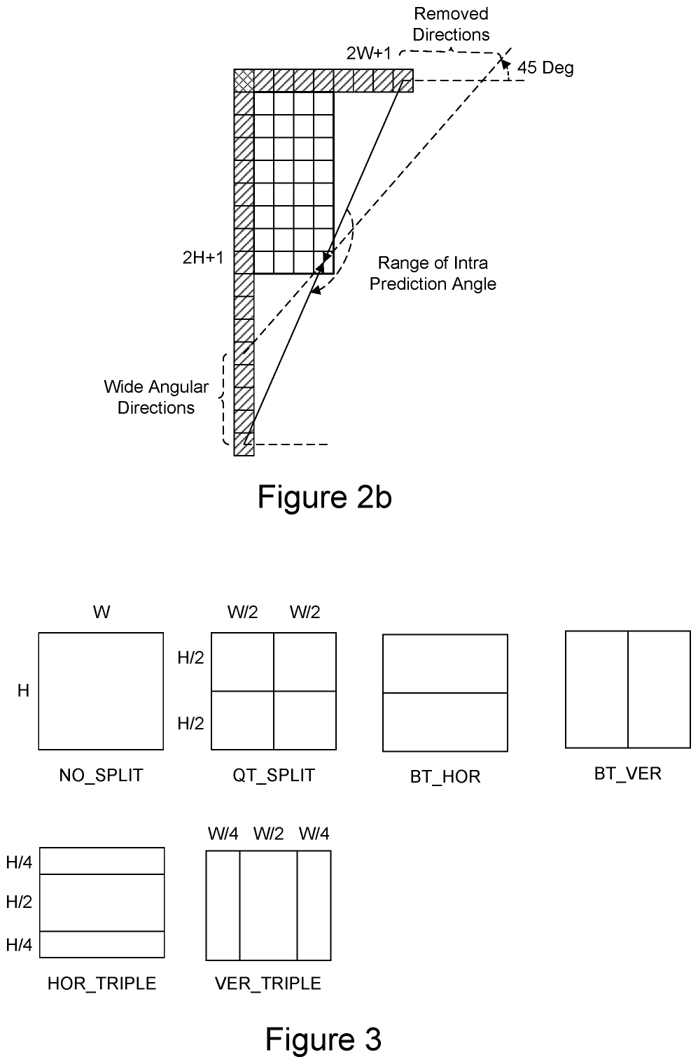

FIGS. 2a and 2b illustrate wide angle intra prediction for non-square blocks according to VVC. The wide angle prediction consists in adapting the prediction directions according to a rectangular block shape while keeping the total number of prediction modes the same. Thus, some prediction directions are added on the larger side of a block while some prediction directions are removed on the shorter side. Advantageously, this adaptation improves the prediction accuracy leading to higher compression efficiency. Since the newly introduced directions are beyond the usual range of 180 degree from 45 degree to −135 degree, they are termed as wide angle directions. The directions −1 to 14, 67 to 80 (dash lines) as shown on FIG. 1 correspond to wide angular modes whereas the others 2 to 66 (straight lines) correspond to the regular angular modes. Table 1 shows the value of the angle parameter intraPredAngle for the wide angular modes. The values of intraPredAngle for all regular angular modes are given in VVC Specification as follows.

TABLE 1
intraPredAngle values for wide angular modes in VVC. Each value corresponds
to two modes one of which is vertical (ver) and the other is horizontal (hor).

| | | | | | | | |
|---|---|---|---|---|---|---|---|
| Mode index | 67/−1 | 68/−2 | 69/−3 | 70/−4 | 71/−5 | 72/−6 | 73/−7 |
| (ver/hor) | | | | | | | |
| intraPredAngle | 35 | 39 | 45 | 51 | 57 | 64 | 73 |
| Mode index | 74/−8 | 75/−9 | 76/−10 | 77/−11 | 78/−12 | 79/−13 | 80/−14 |
| (ver/hor) | | | | | | | |
| intraPredAngle | 86 | 102 | 128 | 171 | 256 | 341 | 512 |

When a target block is of square shape, the wide angle modes have no role to play and only the regular angular modes are selected for prediction. When a target block is flat, that is, its width W is larger than its height H, some modes close to 45 degrees are removed from selection and an equal number of wide angular modes beyond −135 degrees are selected. The wide angle directions are indexed as prediction modes 67, 68, . . . , and so on. Similarly, when a target block is tall, some modes close to −135 degree are removed from selection and an equal number of wide angle modes beyond 45 degree are selected. The wide angle directions are indexed as prediction modes −1, −2, . . . , and so on, as the prediction modes 0 and 1 are reserved for the PLANAR and the DC modes. The selection of the wide angular modes happens by a mapping from the regular angular mode to wide angular modes as follows:

```
modeShift[5] = {0, 6, 10, 12, 14};
ratio = Abs (Log2(W/H))
if W > H and 1 < predMode < 2 + modeShift[ratio]
      predMode = predMode + 65;
else if H > W and (66 − modeShift[ratio]) < predMode <= 66
      predMode = predMode − 67;
```

FIGS. 2a and 2b shows the range of applicable modes for a rectangular block respectively for a flat block (2a) and a tall block (2b). A wide angular mode corresponds to a direction (wide angular directions) that is opposite to the direction (removed directions) associated with the regular angular mode being replaced by the wide angular mode. On FIG. 2a, more top-right vertical modes are added to replace bottom-left horizontal modes for a flat block (W is larger than its height H, W/H>1). On FIG. 2b, more bottom-left horizontal modes are added to replace top-right vertical modes for a tall block (His larger than its height W, W/H<1).

Since the direction of the secondary diagonal depends on the shape of the block, the total number of applicable wide angular modes depends on the shape of a block. Table 2 shows the number of regular modes replaced by wide angle modes for different block shapes.

TABLE 2
Number of wide angular modes depending on the block shape.

| | Range of intra | No of wide | |
|---|---|---|---|
| | prediction | angular | No of regular |
| W/H ratio | modes | modes | angular modes |
| 1 | 2:66 | 0 | 65 |
| 2 | 8:72 | 6 | 59 |
| 4 | 12:76 | 10 | 55 |
| 8 | 14:78 | 12 | 53 |
| 16 | 16:80 | 14 | 51 |
| ½ | −6:−1, 2:60 | 6 | 59 |
| ¼ | −10:−1, 2:56 | 10 | 55 |
| 1/8 | −12:−1, 2:54 | 12 | 53 |
| 1/16 | −14:−1, 2:52 | 14 | 51 |

As Table 1 and Table 2 show, the wide angles have been designed to be applicable to rectangular blocks with aspect ratio equal to a power of 2. In Table 1, intraPredAngle equal to k*32, k=2, 4, 8, 16, indicates the wide angular mode aligned along the secondary diagonal of a CU having its W/H ratio equal to k or 1/k. The other applicable wide angular modes for a

CU are between this mode and mode 66 (2) when the CU is flat (tall). Thus, the number of wide angular modes for any given CU aspect ratio, as given in Table 2, can be equivalently deduced from Table 1. It will be appreciated by the skilled in the art that wide angular intra prediction is performed only at the prediction stage through the mapping process mentioned above. As far as the intra mode coding is concerned, the total number of applicable modes is always 67, and they are indexed from 0 to 66.

However, the current wide angular intra prediction is limited by its design. As the BT and TT lead to rectangular blocks having their sides always equal to powers of 2, the wide angle prediction directions have been selected to correspond to such rectangular blocks where the ratio of the larger side to the smaller side is always a power of 2. For such CUs, the direction along the secondary diagonal is parallel to a wide angle direction, and it decides the number of applicable wide angles to any CU size. Thus, with top and left reference array lengths equal to twice the size of the top and left sides of the CU, respectively, predictions can be constructed for the applicable regular and wide angular modes. However, if a rectangular CU does not satisfy the assumptions on the rectangular shape having an aspect ratio equal to a power of two, as in the case of asymmetric BT, the wide angle prediction cannot be applied as is and needs some modifications. VVC supports quadtree (QT), binary tree (BT), and triple tree (TT) for CU partitioning in intra prediction, where both the width or the height of a partition block is a power of two. Thus, the current design of wide angular prediction on rectangular blocks with aspect ratio equal to a power of 2 are well adapted to VVC partitioning. However, it is desirable to adapt current design of wide angular prediction for rectangular blocks having an aspect ratio not equal to a power of two.

FIG. 3 shows the QT, BT and TT partitions for a CU. QT and BT partition are symmetric in the sense that the split, either type, is at the middle of the CU leading to two identical blocks. TT split mode divides a parent CU into 3 sub-CUs, respectively with sizes 1/4, 1/2 and 1/4 relative to the parent CU in width or height, depending on the split orientation.

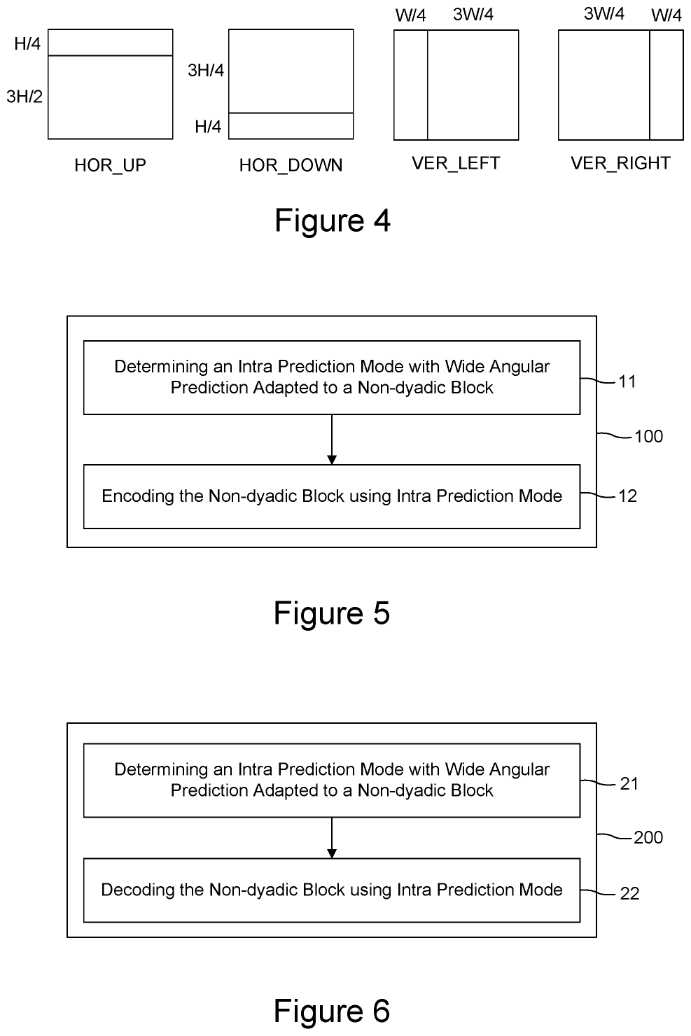

FIG. 4 shows an example of asymmetric partitions for a CU. It has been shown that asymmetric BTs (ABTs) together with the symmetric splits can lead to higher compression efficiency. Each coding stage (BT split signaling, prediction, transform, entropy coding, de-blocking filter) is adapted to new rectangular block sizes where one of width or the height of a partition block is no longer a power of two. According to a non-limiting example of asymmetric partition, these sizes correspond to a CU width or height multiple of 3, resulting from the division of a CU into 2 sub-CU with respective sizes 1/4 and 3/4 the size of the parent CU. Although, the following of the description will use the exemplary ratio (1/4, 3/4) for ABT, the skilled in the art will easily derive the present principles for other examples of ratio for ABT such as 3/8 and 5/8 or any other non-dyadic ratio. In practice, this leads to a CU width or height potentially equal to 12,24, 48 or 86 for the exemplary ratio ABT 1/4, 3/4. As shown in

FIG. 4, a 16×16 CU can be split into two parts asymmetrically as 16×4 and 16×12 (hor_up), or 16×12 and 16×4 (hor_down), or 4×16 and 12×16 (ver_left), or 12×16 and 4×16 (ver_right). Thus, the larger partition does not satisfy the dyadic property as 12 is not a power of 2. Similar cases can be derived for other CU sizes. For these CUs, the wide angular intra prediction as described in the previous section cannot be applied as is.

This is solved and addressed by the general aspects described herein, which are directed to a decoding or an encoding method/device adapting at least one of the angle of a wide angular intra prediction mode or a reference array used by wide angular intra prediction to the width or the height of an image block which is not power of two. In the following sections, a generic embodiment of an encoding method, a generic embodiment of a decoding method using the modified wide angular prediction are described, then various embodiments of a modified wide angular prediction are detailed for CUs which do not satisfy the condition of dyadic split. For ease of reference, we call these CUs non-dyadic CUs.

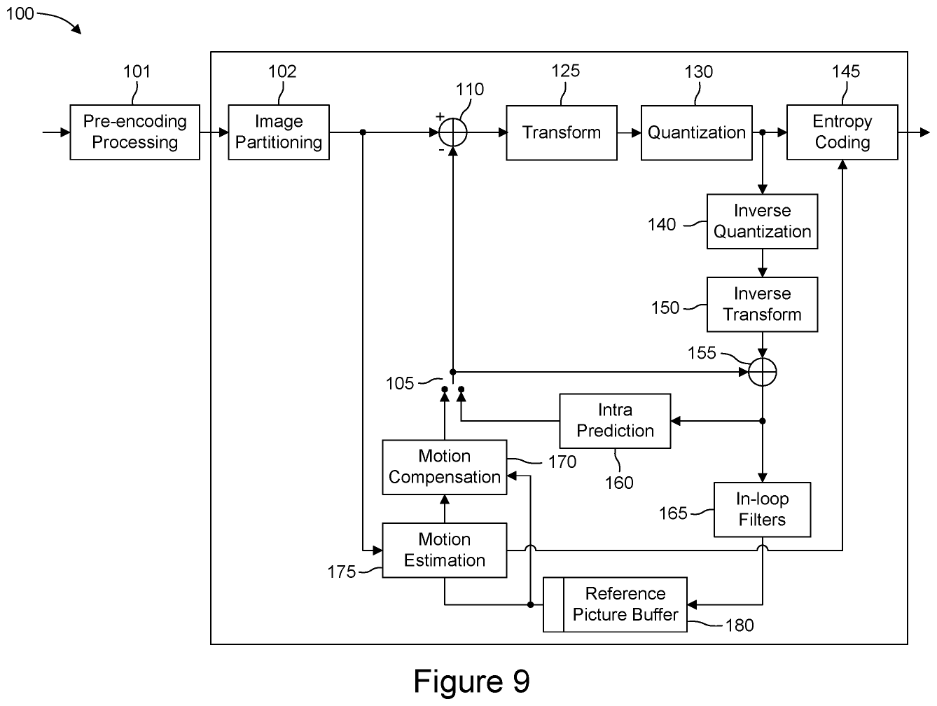

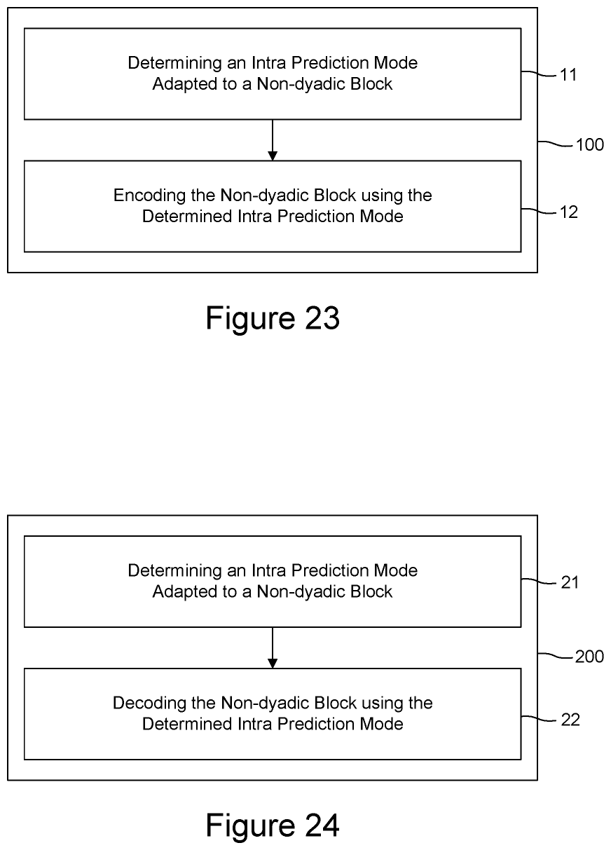

FIG. 5 illustrates a generic encoding method 100 according to a general aspect of at least one embodiment. The block diagram of FIG. 5 partially represents modules of an encoder or encoding method, for instance implemented in the exemplary encoder of FIG. 9. The block diagram of FIG. 5 also corresponds to the generic method of FIG. 23.

According to a generic embodiment a method for encoding 100 is disclosed. The method comprises, for non-dyadic INTRA CUs resulting from ABT partitioning, selecting an intra prediction directions. Thus, the determining 11 of an intra prediction mode from a set of regular angular intra prediction modes and wide angular intra prediction modes for an image block, comprises adapting at least one of an angle of an angular intra prediction mode in the set or a reference array used by the angular intra prediction mode in the set to the width or the height of the image block which is not power of two. The top and left reference arrays are constructed using any of the variants of number of decoded pixels each on the top and left side of the current block. The determining further comprises searching for the prediction mode giving the best RD performance and encodes the mode as specified in a state of the art encoding method. The residual is computed in the usual manner by subtracting the predicted values from the current original pixel values, and then the remaining of the processing (transform, quantization, CABAC encoding, etc.) is performed as in a state of the art encoding method in a generic encoding step 12.

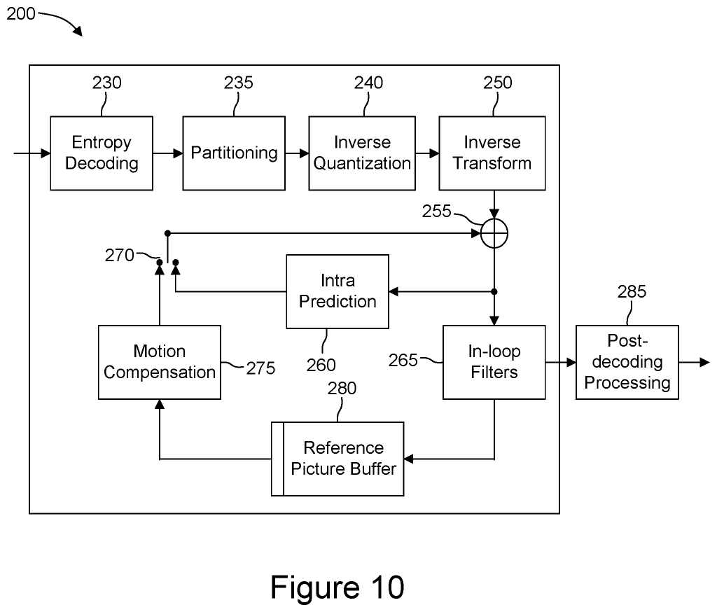

FIG. 6 illustrates a generic decoding method 200 according to a general aspect of at least one embodiment. The block diagram of FIG. 6 partially represents modules of a decoder or decoding method, for instance implemented in the exemplary decoder of FIG. 10. The block diagram of FIG. 6 also corresponds to the generic method of FIG. 24.

According to a generic embodiment a method for decoding 200 is disclosed. The method comprises, for non-dyadic INTRA CUs resulting from ABT partitioning, decoding a prediction mode and selecting the corresponding direction according to any of the disclosed variants. Thus, the determining 11 of an intra prediction mode from a set of regular angular intra prediction modes and wide angular intra prediction modes for an image block, comprises adapting at least one of an angle of an angular intra prediction mode in the set or a reference array used by the angular intra prediction mode in the set to the width or the height of the image block which is not power of two. Then, the top and the left reference arrays of pixels are constructed and then forms the prediction block for the determined prediction direction. The decoding 22 then further comprises decoding the residual values by performing the CABAC decoding, dequantization of the transform coefficients and then the inverse transform of the decoded coefficients, and adding the residual values to the prediction values to decode the current block.

In the following, we will consider that non-dyadic CUs are all rectangular, that is their width and height are unequal, and their width or height is not a power of 2. Besides, we will consider that the number of directional modes applicable for such CUs is still 65, as in VVC. Keeping the number of total prediction modes the same assumes that the intra prediction mode coding is done as in VVC. However, the man skilled in the art would easily extend the present principles to other embodiments of intra prediction mode, for instance with a different number of directional modes. Besides, for ease of presentation, we will consider that a non-dyadic block size H×W being 3h/4×w or h x 3w/4 where h, and w are power of two value. Although the exemplary embodiments are described for the ABT with ratio (1/4,3/4), the present principles are neither limited to ABTs and nor to this ratio. The skilled in the art would easily extend the present principles to wide intra prediction with non-dyadic CUs resulting from any other asymmetric splits.

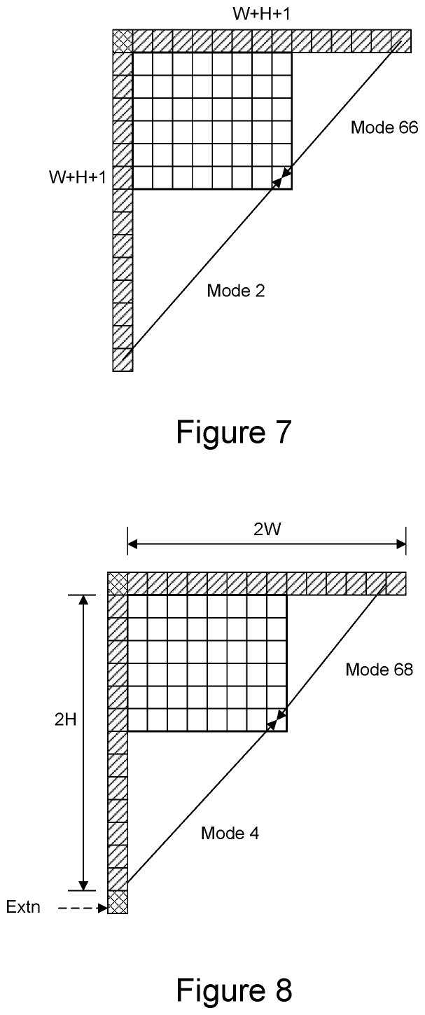

FIG. 7 illustrates a first variant of the wide angular mode adapted to non-dyadic CU according to a general aspect of at least one embodiment. According to the first variant, only regular angular intra prediction modes are allowed and the reference array is extended to size H+W+1. The simplest way to apply intra prediction on the non-dyadic CUs is to consider them as similar to square CUs. That is, when the CU is non-dyadic, only the regular 65 angular modes are used for prediction and no wide angular mode is used. For this, the reference array size is modified to a size equal to H+W+1 as shown in FIG. 7. VVC specifies the top reference array length as 2W+1 and the left reference array length as 2H+1, as shown in FIG. 2. Unlike in VVC, when the CU is non-dyadic, the reference array lengths are set to be equal to H+W+1, Advantageously the prediction modes 2-66 are thus supported. In the case split ratios different from (1/4,3/4) may be used in the asymmetric binary splitting of coding units, for instance (3/8,5/8), then the same method as that of FIG. 7 may apply.

FIG. 8 illustrates a second variant of the wide angular mode adapted to non-dyadic CU according to a general aspect of at least one embodiment. According to the second variant, two wide angles are allowed and reference array is extended to 2H+1, 2H+2 or 2H+4 or 2W+1, 2W+2 or 2W+4, depending on the considered rectangular block size. The first variant does not take advantage of the availability of the wide angular modes as they can still be applied to non-dyadic CUs in the same manner as they are used with dyadic rectangular CUs. However, as the ratio of the longer side to the shorter side is not a power of 2, the number of wide angles is reduced to a maximum number of 2. Furthermore, as the direction along the secondary diagonal of a non-dyadic CU is not specified in VVC, the shorter reference array is extended by a few pixels to support the starting or the ending regular directional mode, as shown in FIG. 8. The extension depends on the CU size. For the ABT partition, the possible non-dyadic CU sizes with the maximum CU size 64 for a luma block and the minimum CU size 2 for the chroma block, are 8×6, 6×8, 16×12, 12×16, 32×24, 24×32, 64×48, and 48×64. For the horizontal blocks (HOR_UP or HOR_DOWN), the width to height ratio W/H is 4/3 and for the vertical blocks (VER_LEFT or VER_RIGHT), the W/H ratio is 3/4. As 4*32/3=42.667, Table 1 shows that only two wide angular modes are supported for these non-dyadic blocks.

TABLE 3
Angular prediction modes for non-dyadic CUs resulting
from ABT in Variant 2

| | Range of | No of | No of | intraPredAngle |
|---|---|---|---|---|
| | intra | wide | regular | of wide |
| | prediction | angular | angular | angular |
| W/H ratio | modes | modes | modes | modes |
| 4/3 | 4:68 | 2 | 63 | 35 (mode: 67), |
| | | | | 39 (mode: 68) |
| 3/4 | −2, −1, 2:64 | 2 | 63 | 39 (mode: −2), |
| | | | | 35 (mode: −1) |

According to a further variant, is the asymmetric splitting support split ratios different from (1/4,3/4), like (3/8,5/8), a further extended set of wide intra prediction modes may be employed. This may take the exemplary form of Table 4.

TABLE 4
Angular prediction modes for non-dyadic CUs resulting
from ABT in Variant 2

| | Range of | No of | No of | intraPredAngle |
|---|---|---|---|---|
| | intra | wide | regular | of wide |
| | prediction | angular | angular | angular |
| W/H ratio | modes | modes | modes | modes |
| 5/3 | 5:69 | 3 | 62 | 35 (mode: 67), |
| | | | | 39 (mode: 68), |
| | | | | 45 (mode: 69) |
| 3/5 | −3, −1, 2:63 | 3 | 62 | 45 (mode: −3), |
| | | | | 39 (mode: −2), |
| | | | | 35 (mode: −1) |

Note also that with the ABT split (1/4,3/4), further block shapes ratios are reachable, like 3/2 (block sizes 12×8, 24×16 and 48×32), 3 (bock sizes 12×4, 24×8, and 48×16), 6 (block sizes 24×4 and 48×8), 12 (block size 48×4), 8/3 (block size 32×12, 64×24), 16/3 (block size 32×6), 32/3 (block size 64×6). For these cases, other variants of the tables 3 and 4 may be used.

The length of the extension of the smaller reference array depends on the block size. Table 5 lists the value of extension in number of pixels. The value is derived using the value of the intraPredAngle for the starting (mode 4 for horizontal blocks) or ending (mode 64 for vertical blocks) angular mode. In either case, the intraPredAngle value is equal to 26.

TABLE 5
Extension of the shorter reference array for non-dyadic
CUs resulting from ABT

| | Extension |
|---|---|
| CU size | pixels |
| 8 × 6, 6 × 8 | 1 |
| 16 × 12, 12 × 16 | 1 |
| 32 × 24, 24 × 32 | 2 |
| 64 × 48, 48 × 64 | 4 |

According to a third variant, the wide angle values are modified and reference array is 2H+1 or 2W+1. The second variant proposes an extension of a few reference pixels on the side of the shorter reference array. This extension is not a big drawback as far as the intra prediction is concerned, however this extension is no longer needed with a small adjustment of the directions. As illustrated in table 2, the required extension results from the fact that the direction corresponding to the secondary diagonal of a non-dyadic CU is not included in VVC specification. The secondary diagonal is the diagonal that links the bottom left corner of the block and the top-right corner of the CU. That is, VVC does not define a mode which is associated with the direction of a secondary diagonal of a non-dyadic CU. The direction corresponds to intraPredAngle equal to 3*32/4=24, and its opposite wide angular direction with intraPredAngle equal to 1024/24=42. Therefore, the third variant comprises modifying the nearest specified angle, which is 23, and the wide angle opposite to it, which is 45, to a direction corresponding the secondary diagonal of a non-dyadic CU, i.e. 24 and 42 as given by the angular direction table 6 below.

TABLE 6
Angular direction table. The top line shows the values of intraPredAngle as specified
in VVC. The bottom line shows the values of intraPredAngle in Variant 3.
The changed values are in underlined.

| | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|
| Original | 0 | 1 | 2 | 3 | 4 | 6 | 8 | 10 | 12 | 14 | 16 | 18 | 20 | 23 | 26 | 29 | 32 | 35 | 39 | 45 | 51 | 57 | 64 | 73 | 86 | 102 | 128 | 171 | 256 | 341 | 512 |
| table | | | | | | | | | | | | | | | | | | | | | | | | | | | | | | | |
| Modified | 0 | 1 | 2 | 3 | 4 | 6 | 8 | 10 | 12 | 14 | 16 | 18 | 20 | 24 | 26 | 29 | 32 | 35 | 39 | 42 | 51 | 57 | 64 | 73 | 86 | 102 | 128 | 171 | 256 | 341 | 512 |
| table | | | | | | | | | | | | | | | | | | | | | | | | | | | | | | | |

This will change the number of applicable wide angles for non-dyadic CUs resulting from ABT to 3, as shown in Table 7, and there is no need of the extension on the smaller reference side.

TABLE 7
Angular prediction modes for non-dyadic CUs resulting
from ABT in third variant

| | Range of | No of | No of | intraPredAngle |
|---|---|---|---|---|
| | intra | wide | regular | of wide |
| | prediction | angular | angular | angular |
| W/H ratio | modes | modes | modes | modes |
| 4/3 | 5:69 | 3 | 62 | 35 (mode: 67), |
| | | | | 39 (mode: 68) |
| | | | | 42 (mode 69) |
| 3/4 | −3:−1, 2:63 | 3 | 62 | 42 (mode: −3) |
| | | | | 39 (mode: −2), |
| | | | | 35 (mode: −1) |

As the angular direction spacing around angles 24 and 42 in Table 6 is not uniform, another angle table can be defined as follows:

TABLE 8
Alternative angular direction table. The top line shows the values of intraPredAngle
as specified in VVC. The bottom line shows the values of intraPredAngle in Variant 3.
The changed values are in underligned.

| | | | | | | | | | | | | | | | | | | | | | | | | | | | | | | | |
|---|---|---|---|---|---|---|---|---|---|---|---|---|---|---|---|---|---|---|---|---|---|---|---|---|---|---|---|---|---|---|---|
| Original | 0 | 1 | 2 | 3 | 4 | 6 | 8 | 10 | 12 | 14 | 16 | 18 | 20 | 23 | 26 | 29 | 32 | 35 | 39 | 45 | 51 | 57 | 64 | 73 | 86 | 102 | 128 | 171 | 256 | 341 | 512 |
| table | | | | | | | | | | | | | | | | | | | | | | | | | | | | | | | |
| Modified | 0 | 1 | 2 | 4 | 6 | 8 | 10 | 12 | 14 | 16 | 18 | 20 | 22 | 24 | 26 | 29 | 32 | 35 | 39 | 42 | 46 | 51 | 57 | 64 | 73 | 86 | 102 | 128 | 171 | 256 | 512 |
| table | | | | | | | | | | | | | | | | | | | | | | | | | | | | | | | |

In this modification, we have additionally introduced a new pair of directions (intraPredAngle=22 and the opposite wide angle with intraPredAngle=46). But as the total number of directions is maintained to be 65, we have removed the direction with intraPredAngle equal to 3 and the wide angle in opposite direction (intraPredAngle=341). Because of the reordering of the directions and the associated modes, Table 2, which specifies the number of wide angles for the BT rectangular blocks, needs to be updated as follows:

TABLE 9
Number of wide angular modes for BT blocks as a function
of block shape if Table 8 is used as angle table.

| | Range of intra | No of wide | No of regular |
|---|---|---|---|
| W/H ratio | prediction modes | angular modes | angular modes |
| 1 | 2:66 | 0 | 65 |
| 2 | 9:73 | 7 | 58 |
| 4 | 13:77 | 11 | 54 |
| 8 | 15:79 | 13 | 52 |
| 16 | 16:80 | 14 | 51 |
| 1/2 | −7:−1, 2:59 | 7 | 58 |
| 1/4 | −11:−1, 2:55 | 11 | 54 |
| 1/8 | −13:−1, 2:53 | 13 | 52 |
| 1/16 | −14:−1, 2:52 | 14 | 51 |

In the third variant, the reference array lengths remain the same as specified in VVC. It is to note that, as the directions are modified slightly and reindexed, the RD performance of dyadic CUs may also change.

Based on the 3 variants, several embodiments are disclosed as possible implementations for intra prediction when ABT, or any other partitioning leading to non-dyadic CUs, supported by VVC or other future video coding standards.

According to a first embodiment, dyadic INTRA CUs undergo encoding and decoding as specified in VVC. For, non-dyadic INTRA CUs resulting from ABT partitioning, intra prediction directions are chosen as in the first variant. The top and left reference arrays are constructed using W+H+1 decoded pixels each on the top and left side of the current block. The encoder 100 searches for the prediction mode giving the best RD performance and encodes the mode as specified in VVC. The residual is computed in the usual manner by subtracting the predicted values from the current pixel values, and then the rest of the processing (transform, quantization, CABAC encoding, etc.) is performed as in VVC. The decoder decodes the prediction mode and selects the corresponding direction from the set of directions in the first variant. It constructs the top and the left reference arrays of length W+H+1 pixels each and then forms the prediction block for the prediction direction. It also decodes the residual values by performing the CABAC decoding, dequantization of the transform coefficients and then the inverse transform of the decoded coefficients. Finally, it adds the residual values to the prediction values to decode the current block.

According to a second embodiment, dyadic INTRA CUs undergo encoding and decoding as specified in VVC. For, non-dyadic INTRA CUs resulting from ABT partitioning, intra prediction directions are chosen as in the second variant with wide angle mapping. The top and left reference arrays are constructed as in VVC with a small extension of the smaller reference array. The encoder searches for the prediction mode giving the best RD performance and encodes the mode as specified in VVC. The residual is computed in the usual manner by subtracting the predicted values from the current pixel values, and then the rest of the processing (transform, quantization, CABAC encoding, etc.) is performed as in VVC. The decoder decodes the prediction mode and selects the corresponding direction from the set of directions in the second variant with wide angle mapping. It constructs the top and the left reference arrays as in VVC with a small extension of the smaller reference array, and then forms the prediction block for the prediction direction. It also decodes the residual values by performing the CABAC decoding, dequantization of the transform coefficients and then the inverse transform of the decoded coefficients. Finally, it adds the residual values to the prediction values to decode the current block.

According to a third embodiment, dyadic INTRA CUs undergo encoding and decoding as specified in VVC. For, non-dyadic INTRA CUs resulting from ABT partitioning, intra prediction directions are chosen as in the third variant with wide angle mapping. The top and left reference arrays are constructed as in VVC. The encoder searches for the prediction mode giving the best RD performance and encodes the mode as specified in VVC. The residual is computed in the usual manner by subtracting the predicted values from the current pixel values, and then the rest of the processing (transform, quantization, CABAC encoding, etc.) is performed as in VVC. The decoder decodes the prediction mode and selects the corresponding direction from the set of directions in the third variant with wide angle mapping. It constructs the top and the left reference arrays as in VVC, and then forms the prediction block for the prediction direction. It also decodes the residual values by performing the CABAC decoding, dequantization of the transform coefficients and then the inverse transform of the decoded coefficients. Finally, it adds the residual values to the prediction values to decode the current block.

According to a fourth embodiment, the intra prediction directions specified in the second or the third variant are used for a non-dyadic CU only when the relevant reference samples are available. For example, in the case of a flat block, the second or third variant selects 2 or 3 directions after +135°. However, independently of the current block shape, top right neighboring blocks may not be available. In that case, current CU will be intra predicted as in the first variant. As both encoder and decoder can easily detect the presence of reconstructed neighboring blocks, they will decide, in identical manner, if to apply any of the second/third variant, or the first variant.

According to a fifth embodiment, the encoder selects between the first variant, and the second or third variant, for deciding on intra prediction directions for non-dyadic CUs using a one bit flag. The flag is signaled to the decoder in the slice header.

According to a sixth embodiment, the encoder selects between the first variant, and the second or third variant, for deciding on intra prediction directions for non-dyadic CUs using a one bit flag. The flag is signaled to the decoder in the Picture Parameter Set (PPS) header.

According to a seventh embodiment, the encoder selects between the first variant, and the second or third variant, for deciding on intra prediction directions for non-dyadic CUs using a one bit flag. The flag is signaled to the decoder in the Sequence Parameter Set (SPS) header.

According to an eighth embodiment, the encoder selects between the first variant, and the second or third variant, for deciding on intra prediction directions for non-dyadic CUs based on the size of blocks. Indeed, for certain ratios between the processed block width and height, the first variant may be used, while for certain other ratios, the second or third variant may be used.

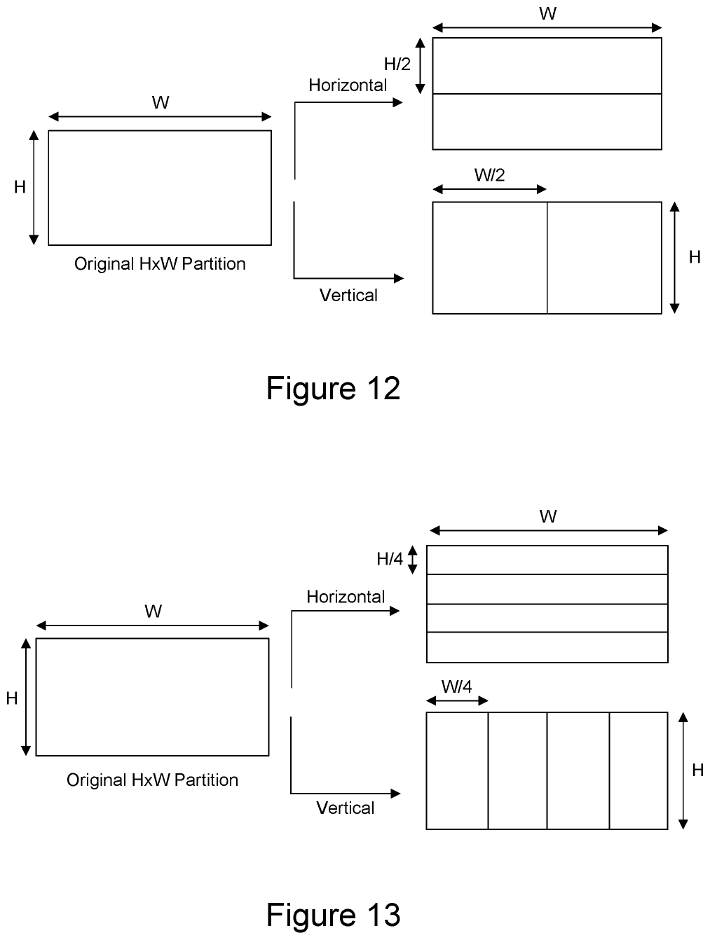

FIGS. 12 and 13 illustrate examples of intra sub partition according to Versatile Video Coding VVC. In VVC, intra prediction is applied in all-Intra frames as well as in intra blocks in Inter frames, where a target block, called a coding unit (CU), is spatially predicted from the causal neighbor blocks in the same frame, i.e., the blocks on the top and top-right, the blocks on the left and left-bottom, and the top-left block. Based on the decoded pixel values in these blocks, the encoder constructs different predictions for the target block and chooses the one that leads to the best rate-distortion (RD) performance. The predictions are tested for 67 prediction modes, which include one PLANAR mode (indexed as mode 0), one DC mode (indexed as mode 1) and remaining 65 angular modes. A target block has the option of choosing between the intra prediction for the entire CU and the intra prediction with sub-partitions (ISP) of the CU. In the first method, all the target pixels are predicted at the same time based on the reference samples for the entire CU in the classical manner. In the second method, the target CU is divided into two or four equal sized sub-partitions that are sequentially decoded with the prediction mode of the CU. That is, each sub-partition is independently decoded where its target pixels are predicted using its own reference samples. Thus, a sub-partition can benefit from the availability of the decoded samples from the neighboring sub-partition, which are immediate neighbors of the current sub-partition. This can lead to better prediction and compression efficiency than the first method in some cases. As shown on FIGS. 12 and 13, the ISP tool divides luma intra-predicted blocks vertically or horizontally into 2 or 4 sub-partitions. The number of partitions depends on the block size, as shown in Table 10. A sub-partition must have at least 16 samples. Therefore, blocks of size 4×4 are not divided into sub-partitions whereas blocks of size 4×8 and 8×4 have only two partitions. Blocks of all other sizes have four sub-partitions.

TABLE 10
Number of sub-partitions depending on the block size

| Block Size | Number of Sub-Partitions |
|---|---|
| 4 × 4 | 1 |
| 4 × 8 and 8 × 4 | 2 |
| All other cases | 4 |

The sub-partitions can be either horizontal or vertical. A block of size 4×8 can have only two vertical partitions of size 4×4 each whereas a block of size 8×4 can have only two horizontal partitions of size 4×4 each. Similarly, a block of size 4×16, as another example, can have four vertical sub-partitions of size 4×4 each or four horizontal sub-partitions of size 1×16 each.

For each of these sub-partitions, a prediction is constructed using the decoded prediction mode of the parent CU. This prediction signal is added to the decoded residual signal, which is generated by entropy decoding the coefficients sent by the encoder and then inverse quantizing and inverse transforming them, to reconstruct the pixels in a sub-partition. Except the first sub-partition, the reconstructed values of each sub-partition are available to generate the prediction of the next one. The sub-partitions are processed in the normal order irrespective of the intra prediction mode and the split utilized, that is, the first sub-partition to be processed is the one containing the top-left sample of the CU and then continuing downwards (horizontal split) or to the right (vertical split), sequentially. The split-type of a CU is transmitted using either bit ‘0’ (NO_SPLIT), or bits ‘10’ or ‘11’ (HOR_SPLIT and VER_SPLIT).

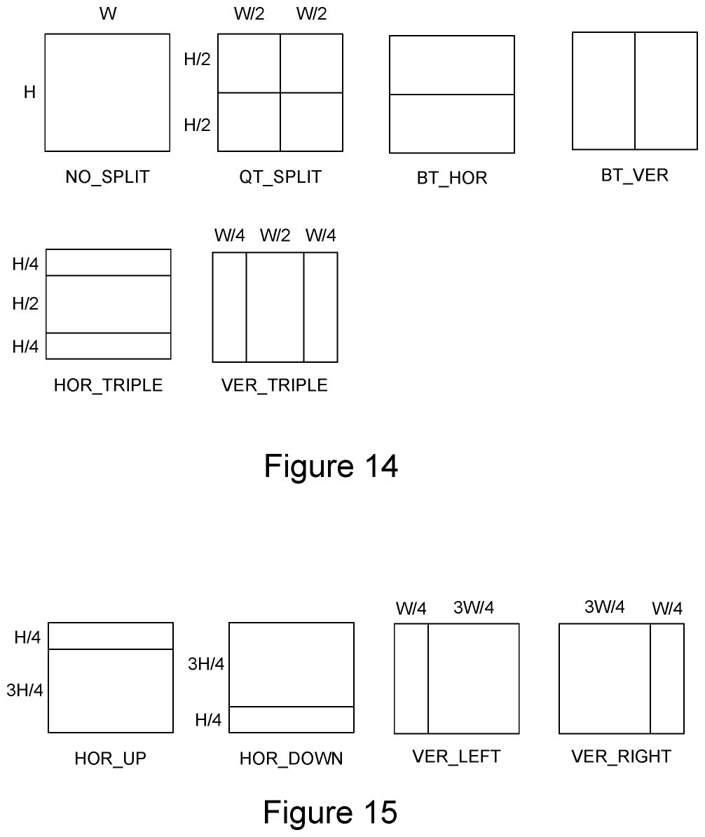

FIG. 14 shows the QT, BT and TT partitions for a CU according to VVC. QT and BT partition are symmetric in the sense that the split, either type, is at the middle of the CU leading to two identical blocks. FIG. 15 shows an example of asymmetric partitions for a CU. It has been shown that asymmetric BTs (ABTs) together with the symmetric splits can lead to higher compression efficiency. Each coding stage (BT split signaling, prediction, transform, entropy coding, de-blocking filter) is adapted to new rectangular block sizes where one of width or the height of a partition block is no longer a power of two. According to a non-limiting example of asymmetric partition, these sizes correspond to a CU width or height multiple of 3, resulting from the division of a CU into 2 sub-CU with respective sizes 1/4 and 3/4 the size of the parent CU. Although, the following of the description will used the exemplary ratio (1/4, 3/4) for ABT, the skilled in the art will easily derive the present principles for other examples of ratio for ABT such as 3/8 and 5/8 or any other non-dyadic ratio. In practice, this leads to a CU width or height potentially equal to 12, 24, 48 or even 96 (in a codec design non compliant and less restricted than VVC) for the exemplary ratio ABT 1/4, 3/4. As shown in FIG. 15, a 16×16 CU can be split into two parts asymmetrically as 16×4 and 16×12 (hor_up), or 16×12 and 16×4 (hor_down), or 4×16 and 12×16 (ver_left), or 12×16 and 4×16 (ver_right). Thus, the larger partition does not satisfy the dyadic property as 12 is not a power of 2. Similar cases can be derived for other CU sizes. For these CUs, the ISP as described above cannot be applied as is, since it would require transforms of size 3, 6, etc. when the CU side has a width or a height equal to 12, 24, etc., is divided into 4 for sub-partitions, and these transform sizes may not be supported.

This is solved and addressed by the general aspects described herein, which are directed to a decoding or an encoding method/device wherein at least one of a size of an intra sub-partition or a number of intra sub-partitions are adapted to the width or the height of the image block which is not a power of two. For ease of reference, we call these image blocks or CUs non-dyadic CUs.

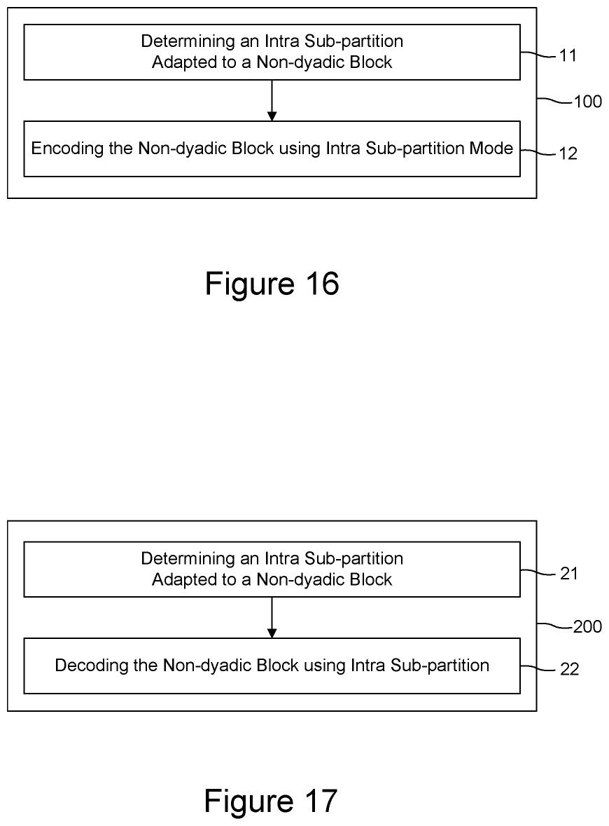

FIG. 16 illustrates a generic encoding method 100 according to a general aspect of at least one embodiment. The block diagram of FIG. 16 partially represents modules of an encoder or encoding method, for instance implemented in the exemplary encoder of FIG. 12. The block diagram of FIG. 16 also corresponds to the generic method of FIG. 23. According to a generic embodiment a method for encoding 100 is disclosed. The method comprises, for non-dyadic INTRA CUs resulting from ABT partitioning, selecting an intra sub partition. Thus, the determining 11 of an intra sub partition mode, comprises adapting one of a size of an intra sub-partition or a number of intra sub-partitions used in an intra sub-partition mode to the width or the height of the image block which is not power of two. The determining further comprises searching for the intra prediction mode and sub partition giving the best RD performance and encodes the mode as specified in a state-of-the-art encoding method. The residual is computed in the usual manner by subtracting the predicted values from the current pixel values, and then the remaining processing (transform, quantization, CABAC encoding, etc.) is performed as in a state-of-the-art encoding method in a generic encoding step 12.

FIG. 17 illustrates a generic decoding method 200 according to a general aspect of at least one embodiment. The block diagram of FIG. 17 partially represents modules of a decoder or decoding method, for instance implemented in the exemplary decoder of FIG. 13. The block diagram of FIG. 17 also corresponds to the generic method of FIG. 24.

According to a generic embodiment a method for decoding 200 is disclosed. The method comprises, for non-dyadic INTRA CUs resulting from ABT partitioning, decoding an intra prediction mode and obtaining the intra sub partitions according to any of the disclosed variants. Thus, the determining 21 of an intra sub partition mode, comprises adapting at least one of a size of an intra sub-partition or a number of intra sub-partitions used in an intra sub-partition mode to the width or the height of the image block which is not power of two. The decoding 22 then further comprises decoding the residual values by performing the CABAC decoding, dequantization of the transform coefficients and then the inverse transform of the decoded coefficients and adding the so-decoded residual values to the prediction values to decode the current block.

In the following, 3 variants embodiments for applying ISP to an asymmetric CU resulting from ABT are presented. However, the variants are not limited to ABT alone and can be applied to asymmetric CUs resulting from any other CU partitioning. Thus, we will consider that non-dyadic CUs are all rectangular, that is their width and height are unequal, and their width or height is not a power of 2. For ease of presentation, we will consider that a non-dyadic block size being W×3H/4 or 3W/4×H where W and H are power of two value. In other words, size w×h is the size of the asymmetric partition resulting from the asymmetric split of a parent CU of size W×H, where the width W and the height H are power of two values while at least one of the width w=3W/4 or the height h=3H/4 is not a power of two values. Besides, although the exemplary embodiments are described for the ABT with ratio (1/4,3/4), the present principles are neither limited to ABTs and nor to this ratio. The skilled in the art would extend the present principles to intra sub-partition with non-dyadic CUs resulting from asymmetric TTs or any other asymmetric splits. For instance, the (3/8,5/8), (1/8,7/8) may be considered as well. According to further examples, split ratios (5/16,11/16), (7/16,9/16) may also be considered, for the case of parent CU size equal to a multiple of 16 in with or height. To distinguish between the split type in ISP and in CU partitioning, we will refer to the former as ISP_SPLIT_TYPE and to the latter as ABT_SPLIT_TYPE, where ABT_SPLIT_TYPE can be any of the four split types shown in FIG. 15, namely HOR_UP, HOR_DOWN, VERT_LEFT, VER_RIGHT. All sub-partitions use the intra prediction mode of the parent asymmetric CU for intra prediction. It is assumed that they are processed in sequential order as in ISP applied to dyadic CUs, however, this assumption is not a constraint for any of the variants and any other processing order can be followed. For example, the processing order of the sub-partitions can be dependent on the directionality of the prediction mode.

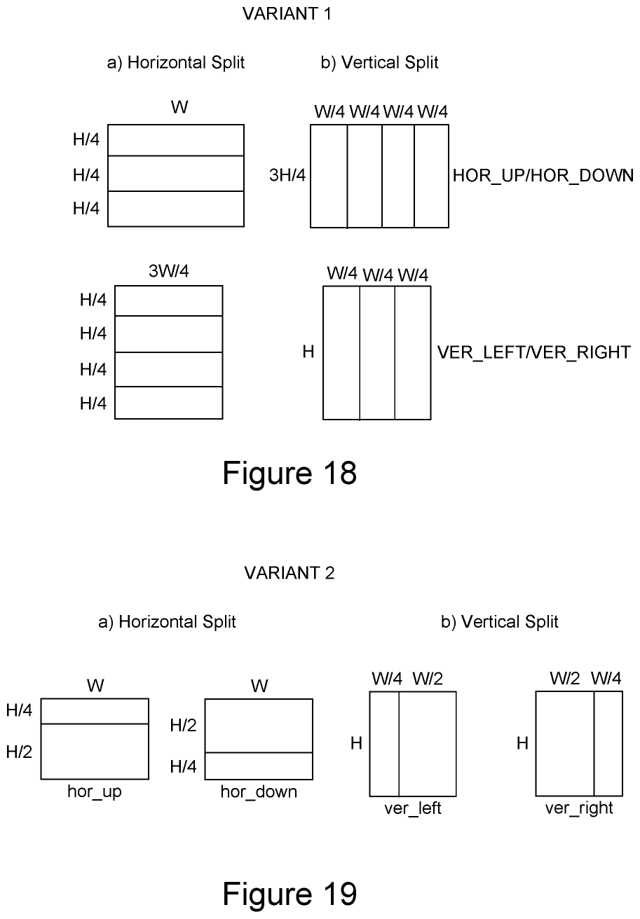

FIG. 18 illustrates a first variant of intra sub partition adapted to non-dyadic CU according to a general aspect of at least one embodiment. According to the first variant, a horizontal intra sub-partition mode is modified and results into three sub-partitions of size W×H/4 for an image block of size W×3H/4. Moreover, a horizontal intra sub-partition mode results into four sub-partitions of size 3W/4×H/4 for an image block of size 3W/4×H, following the existing VVC ISP splitting rules of Table 10.

Note however that for a CU of size 12×4, horizontal ISP split leads to 4 intra sub partitions of size 12×1 according to the present ISP splitting method, leading to sub partitions of 12 luma samples each.

In VVC specification, a sub partition must comprise at least 16 luma samples. Thus, according to another variant, the horizontal ISP splitting of 12×4 CUs leads to 2 sub partitions of size 12×2, thus comprising 24 luma samples each.

Respectively, a vertical intra sub-partition mode results into four sub-partitions of size W/4×3H/4 for an image block of size 3W/4×H while a vertical intra sub-partition mode is modified and results into three sub-partitions of size W/4×H for an image block of size 3W/4×H. The horizontal and vertical split of non-dyadic CUs are illustrated on FIG. 18. As shown on the upper part of FIG. 18, if the CU is of type HOR (resulting from either HOR_UP or HOR_DOWN ABT split), in horizontal split, it is split into three sub-partitions of height H/4 and width W each. Each sub-partition of size W×H/4 has at least 16 pixels and the numbers of pixels is a multiple of 16.

Note however that for a CU of size 4×12, the vertical ISP split leads to 4 intra sub partitions of size 1×12 according to the present ISP vertical splitting method, leading to sub partitions of 12 luma samples each.

In VVC specification, a sub partition must comprise at least 16 luma samples. Thus, according to another variant, the vertical ISP splitting of CU with size 4×12 leads to 2 sub partitions of size 2×12, thus comprising 24 luma samples each.

According to a variant of the embodiment of FIG. 18, a CU of size 3W/4×H is split vertically into three sub-partitions only if the VVC splitting rules of ISP lead to a sub-partition with a transform size that is not supported in the considered codec design. For instance, in the case of a CU of size 24×8, it can be split into 4 sub-partitions of size 6×8, if the transform size 6 is supported in the considered codec design. If the transform size 6 is not supported, then the CU is split vertically into 3 sub-partitions of width 8, which is a power of two.

Similarly, according to this variant, a CU of size W×3H/4 is split horizontally into three sub-partitions only if the VVC splitting rules of ISP lead to a sub-partition with a transform size that is not supported in the considered codec design. For instance, in the case of a CU of size 8×24, it can be split into 4 sub-partitions of size 8×6, if the transform size 6 is supported in the considered codec design. If the transform size 6 is not supported, then the CU is split horizontally into 3 sub-partitions of height 8, which is a power of two.

In vertical split, the intra sub-partition split remains unchanged and the block is split into four sub-partitions of width W/4 and height 3H/4 and each. In this case, the sub-partitions of size W/4×3H/4 have a number of pixels which is not a power of two. This variant assumes that transforms of size 3H/4 and 3W/4 are supported, that is transform with a number of pixels neither being equal to 16, nor being of power of two. This transform size is the same transform size required for the parent asymmetric CU ie 3H/4×W or H×3H/4 where H and W are powers of 2. Similarly, as shown on the lower part of FIG. 18, if the CU is of type VER (resulting from either VER_LEFT or VER_RIGHT split), in horizontal split, it is split into four sub-partitions of width 3W/4 and height H/4 each. In vertical split, it is split into three sub-partitions of width W/4 and height H each, thus compatible with transform size having a power of two number of pixels.

According to a variation of the first variant, a horizontal intra sub-partition mode results into three sub-partitions of size W×H/4 for an image block of size W×3H/4, while a horizontal intra sub-partition mode results into 2 sub-partitions of size 3W/4×H/2 for an image block of size 3W/4×H. Respectively, a vertical intra sub-partition mode results into two sub-partitions of size W/2×3H/4 for an image block of size W×3H/4 or a vertical intra sub-partition mode results into three sub-partitions of size W×H/4 for an image block of size W×3H/4. That is, if the CU is of type HOR, in vertical split, it is split into two sub-partitions of width W/2 and height 3H/4 each, instead of four sub-partitions. Similarly, if the CU is of type VER, in horizontal split, it is split into two sub-partitions of width 3W/4 and height H/2 and each, instead of four sub-partitions.

As previously explained, the first variant assumes that transforms of size 3H/4 and 3W/4 are supported, that is transform with a number of pixels neither being equal to 16, nor being of power of two, which is the same transform size required for the parent asymmetric CU i.e. 3H/4×W or H×3W/4 where H and W are power of 2. If non-dyadic transforms are not supported at all, and only dyadic transforms are used, in another variation of the first variant, the asymmetric CU is always split in ISP. If it is of type HOR, then it is split horizontally into three sub-partitions. Similarly, if it is of type VER, it is split vertically into three sub-partitions. In this case, the ISP mode flag, which signals NO_SPLIT or HOR-SPLIT or VER_SPLIT, is not transmitted as the type of split is implicit.

FIG. 19 illustrates a second variant of intra sub partition adapted to non-dyadic CU according to a general aspect of at least one embodiment. According to the second variant, a horizontal-up intra sub-partition mode is modified and results into two sub-partitions of size W×H/4 for the upper intra sub-partition and W×H/2 for the lower intra sub-partition for an image block of size W×3H/4 or a horizontal-down intra sub-partition mode results into two sub-partitions of size W×H/2 for the upper intra sub-partition and W×H/4 for the lower intra sub-partition for an image block of size W×3H/4. Respectively, a vertical-left intra sub-partition mode is modified and results into two sub-partitions of size W/4×H for the left intra sub-partition and W/2×H for the right intra sub-partition for an image block of size 3W/4×H or a vertical-right intra sub-partition mode is modified and results into two sub-partitions of size of size W/2×H for the left intra sub-partition and W/4×H for the right intra sub-partition for an image block of size 3W/4×H. The asymmetric CUs are split horizontally and vertically as illustrated in FIG. 19. If the CU is of type HOR (resulting from ABT_SPLIT_TYPE of either HOR_UP or HOR_DOWN), it has only two horizontal splits, namely hor_up and hor_down, but no vertical split is permitted. In the hor_up case, the CU is partitioned into two sub-partitions where the upper sub-partition has height H/4 and width W, whereas the lower sub-partition has height H/2 and width W. In the hor_down case, there are again two sub-partitions where the upper sub-partition has height H/2 and width W, and the lower sub-partition has height H/4 and width W. If the CU is of type VER (resulting from ABT_SPLIT_TYPE of either VER_LEFT or VER_RIGHT), it has only two vertical splits, namely ver_left and ver_right. In either of these two cases, the ISP mode flag is used to signal either one of the two horizontal splits (hor_up and hor_down for asymmetric CUs of HOR type) or either one of the two vertical splits (ver_left and ver_right for asymmetric CUs of VER type).

Advantageously, the splitting method is compatible with transforms having a number of pixels equal to a power of two with ISP. Therefore, if transforms with a number of pixels not multiple of 4 or 16 are not allowed, in another variation of the second variant, the asymmetric CUs are always split into two sup-partitions depending on its ABT_SPLIT_TYPE. The ISP mode flag can be signaled with only one bit to indicate whether the upper or lower split (hor_up and hor_down for asymmetric CUs of HOR type) or, the left or the right split (ver_left and ver_right for asymmetric CUs of VER type) is performed.

According to additional variants, the intra sub partition adapted to non-dyadic CU combines first and second variants. Various combinations are possible.

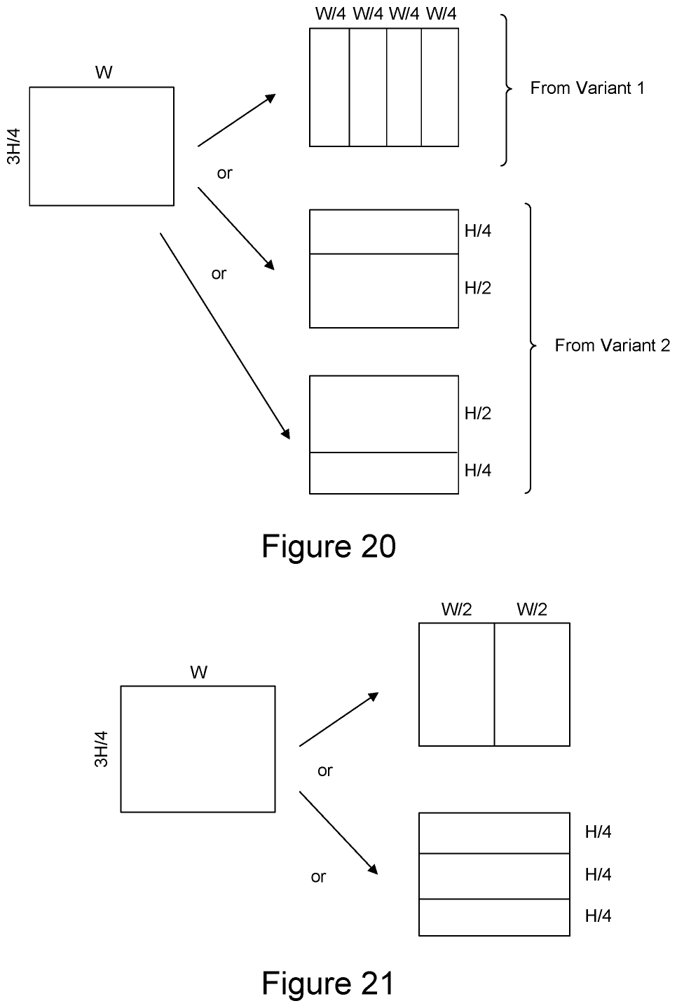

FIG. 20 illustrates a third variant of intra sub partition adapted to non-dyadic CU according to a general aspect of at least one embodiment. For example, in one additional variant, for ABT_SPLIT_TYPE of HOR_UP and HOR_DOWN, the ISP horizontal split type is hor_up and hor_down respectively as in the second variant, the CU split into 2 sub-partitions horizontally of size W/4×H and/or W/2×H, and vertical split type is as in first variant, that is, the CU is split into 4 sub-partitions vertically. Similarly, for ABT_SPLIT_TYPE of VER_LEFT and VER_RIGHT, the ISP vertical split type is ver_left and ver_right respectively as in the second variant, and horizontal split type is as in the first variant.

FIG. 21 illustrates a fourth variant of intra sub partition adapted to non-dyadic CU according to a general aspect of at least one embodiment. In the fifth variant, if the CU is of type HOR (resulting from either HOR_UP or HOR_DOWN ABT_SPLIT_TYPE), the CU is split three horizontal partitions of equal size W×H/4 or the CU is split into two vertical partitions of equal size W/2×3H/4 as shown on FIG. 21. Similarly, if the CU is of type VER (resulting from either VER LEFT or VER_RIGHT ABT_SPLIT_TYPE), the CU is split into three vertical partitions of size W/4×H or the CU is split into two vertical partitions of equal size 3W/4×H/2.

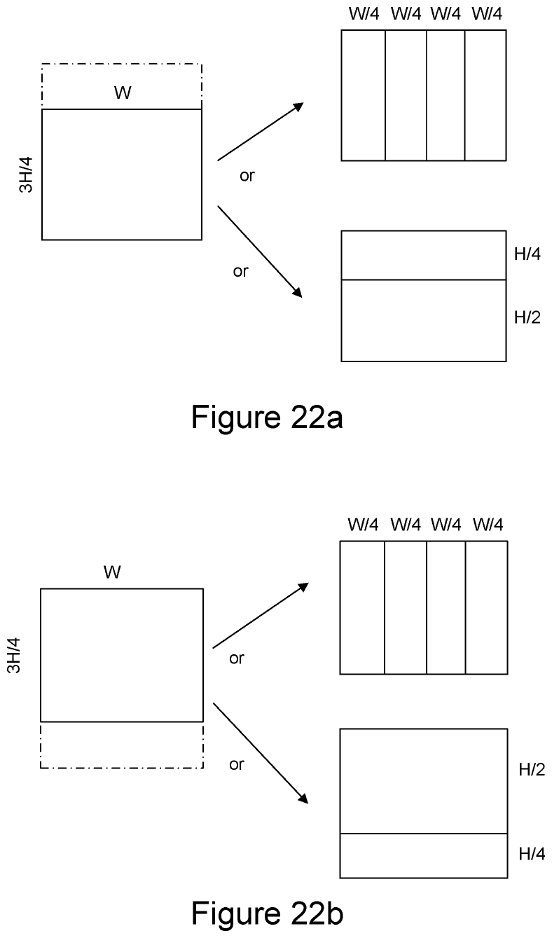

FIGS. 22a and 22b illustrate a fifth variant of intra sub partition adapted to non-dyadic CU according to a general aspect of at least one embodiment. In the fifth variant, if the CU is of type HOR (resulting from either HOR_UP or HOR_DOWN ABT_SPLIT_TYPE), the CU is split two horizontal partitions of size W×H/2 and W×H/4 as shown on FIGS. 22a and 22b. Similarly, if the CU is of type VER (resulting from either VER_LEFT or VER_RIGHT ABT_SPLIT_TYPE), the CU is split into two vertical partitions of size W/2×H and W/4×H (not shown on FIGS. 22a and 22b). According to an additional feature, the type of ISP split corresponds to the type of ABT_SPLIT_TYPE. That is, if the ABT_SPLIT_TYPE is HOR_UP as shown on FIG. 22a, the ISP_SPLIT_TYPE is hor_up, and if the ABT_SPLIT_TYPE is HOR_DOWN as shown on FIG. 22b, the ISP_SPLIT_TYPE is hor_down. Similarly, if the ABT_SPLIT_TYPE is VER_LEFT, the ISP_SPLIT_TYPE is ver_left, and if the ABT_SPLIT_TYPE is VER_RIGHT, the ISP_SPLIT_TYPE is ver_right. Advantageously, the fifth variant saves bit in the signaling since the ISP_SPLIT_TYPE is implicitly derived from the ABT_SPLIT_TYPE.

Thus, from the above exemplary variant embodiments for the ratio (1/4, 3/4), a generic embodiment for a ratio r where r is a positive rational number less than 1 such that rH or rW is a positive integer different from a power of 2 is now described. Advantageously, the ratio r is selected to lead to transform size supported by the considered video codec. We now consider that the intra sub-partition mode results into p sub-partitions, p being a positive integer.

According to a first generic variant corresponding to the exemplary variant of FIG. 18, a vertical intra sub-partition mode results into p sub-partitions of size

$$\frac{r}{p} W \times H$$

for an image of size rW×H, where r is a positive rational number less than 1, and p is a positive integer such that rW is a positive integer different from a power of 2, and

$$\frac{r}{p} W$$

corresponds to a transform size supported by the considered video codec. Similarly, a horizontal intra sub-partition mode results into p sub-partitions of size

$$W \times \frac{r}{p} H$$

for an image block or size W×rH, where r is a positive rational number less than 1, and p is a positive integer such that rH is a positive integer different from a power of 2, and

$$\frac{r}{p} H$$

corresponds to a transform size supported by the considered video codec.

According to a second generic variant corresponding to the exemplary variant of FIG. 19, a horizontal-up intra sub-partition mode results into two sub-partitions of size

$$W \times \frac{r}{p} H$$

for the upper intra sub-partition and

$$W \times ( r - \frac{r}{p} ) H$$

for the lower intra sub-partition for an image block of size W×rH, such that the transform sizes

$$\frac{r}{p} H and ( r - \frac{r}{p} ) H$$

are supported by the considered codec design. In a refinement, such that the transform sizes

$$\frac{r}{p} H and ( r - \frac{r}{p} ) H$$

are both equal to a power of 2. Similarly, a vertical-left intra sub-partition mode results into two sub-partitions of size

$$\frac{r}{p} W \times H$$

for the left intra sub-partition and

$$( r - \frac{r}{p} ) W \times H$$

for the right intra sub-partition for an image block of size rW×H, such that the transform sizes

$$\frac{r}{p} W and ( r - \frac{r}{p} ) W$$

are supported by the considered video codec. According to another variant, one of a horizontal-up intra sub-partition mode or a horizontal-down intra sub-partition mode is used for an image block of size

W×rH and wherein one of a vertical-left intra sub-partition mode or a vertical-right intra sub-partition mode is used for an image block of size rW×H. According to others generic variant embodiments, any of the combinations of variants described for the ratio 3/4 are compatible with the ratio r.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

FIG. 23 illustrates a generic encoding method 100 according to a general aspect of at least one embodiment. The block diagram of FIG. 23 partially represents modules of an encoder or encoding method, for instance implemented in the exemplary encoder of FIG. 9. The block diagram of FIG. 23 also corresponds to the method of FIG. 5 or FIG. 16.

According to a generic embodiment a method for encoding 100 is disclosed. The method comprises, for non-dyadic INTRA CUs resulting from ABT partitioning, selecting an intra prediction mode. Thus, the determining 11 of an intra prediction mode for an image block, comprises adapting at least one of intra prediction mode in a set of possible configurations for intra prediction to the width or the height of the image block which is not power of two. The determining further comprises searching for the prediction mode (angular prediction, intra-sub partition) giving the best RD performance and encodes the mode as specified in a state-of-the-art encoding method. The residual is computed in the usual manner by subtracting the predicted values from the current original pixel values, and then the remaining of the processing (quantization, CABAC encoding, etc.) is performed as in a state-of-the-art encoding method in a generic encoding step 12.

FIG. 24 illustrates a generic decoding method 200 according to a general aspect of at least one embodiment. The block diagram of FIG. 24 partially represents modules of a decoder or decoding method, for instance implemented in the exemplary decoder of FIG. 10. The block diagram of FIG. 6 also corresponds to the method of FIG. 6 or FIG. 17.

According to a generic embodiment a method for decoding 200 is disclosed. The method comprises, for non-dyadic INTRA CUs resulting from ABT partitioning, decoding an intra prediction mode and selecting the corresponding mode according to any of the disclosed variants. Thus, the determining 11 of an intra prediction mode for an image block, comprises adapting at least one of intra prediction mode (angular prediction, intra sub-partition) in a set of possible configurations for intra prediction to the width or the height of the image block which is not power of two. The decoding 22 then further comprises decoding the residual values by performing the CABAC decoding, dequantization of the transform coefficients and then the inverse transform of the decoded coefficients, and adding the residual values to the prediction values to decode the current block.

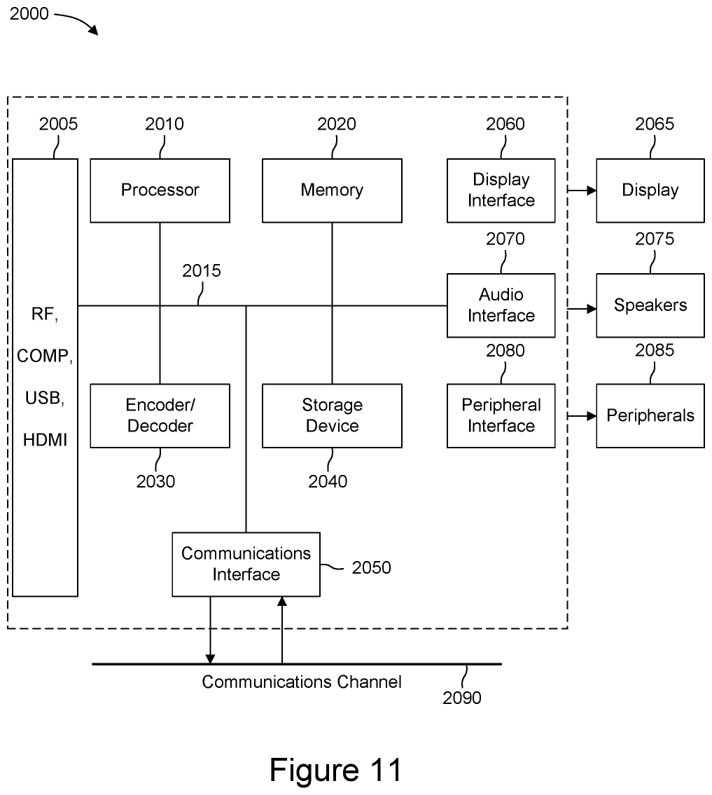

The aspects described and contemplated in this application can be implemented in many different forms. FIG. 9, FIG. 10 and FIG. 11 below provide some embodiments, but other embodiments are contemplated, and the discussion of FIG. 9, FIG. 10 and FIG. 11 does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application can be used to modify modules, for example, the intra prediction module (160, 260), of a video encoder 100 and decoder 200 as shown in FIG. 9 and FIG. 10. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application, for example, the number of angular directions, the block size. The specific values are for example purposes and the aspects described are not limited to these specific values.

FIG. 9 illustrates an encoder 100. Variations of this encoder 100 are contemplated, but the encoder 100 is described below for purposes of clarity without describing all expected variations.

Before being encoded, the video sequence may go through pre-encoding processing (101), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 100, a picture is encoded by the encoder elements as described below. The picture to be encoded is partitioned (102) and processed in units of, for example, CUs. Each unit is encoded using, for example, either an intra or inter mode. When a unit is encoded in an intra mode, it performs intra prediction (160). In an inter mode, motion estimation (175) and compensation (170) are performed. The encoder decides (105) which one of the intra mode or inter mode to use for encoding the unit, and indicates the intra/inter decision by, for example, a prediction mode flag. Prediction residuals are calculated, for example, by subtracting (110) the predicted block from the original image block.

The prediction residuals are then transformed (125) and quantized (130). The quantized transform coefficients, as well as motion vectors and other syntax elements, are entropy coded (145) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (140) and inverse transformed (150) to decode prediction residuals. Combining (155) the decoded prediction residuals and the predicted block, an image block is reconstructed. In-loop filters (165) are applied to the reconstructed picture to perform, for example, deblocking/SAO (Sample Adaptive Offset) filtering to reduce encoding artifacts. The filtered image is stored at a reference picture buffer (180).

FIG. 10 illustrates a block diagram of a video decoder 200. In the decoder 200, a bitstream is decoded by the decoder elements as described below. Video decoder 200 generally performs a decoding pass reciprocal to the encoding pass as described in FIG. 5. The encoder 100 also generally performs video decoding as part of encoding video data.

In particular, the input of the decoder includes a video bitstream, which can be generated by video encoder 100. The bitstream is first entropy decoded (230) to obtain transform coefficients, motion vectors, and other coded information. The picture partition information indicates how the picture is partitioned. The decoder may therefore divide (235) the picture according to the decoded picture partitioning information. The transform coefficients are de-quantized (240) and inverse transformed (250) to decode the prediction residuals. Combining (255) the decoded prediction residuals and the predicted block, an image block is reconstructed. The predicted block can be obtained (270) from intra prediction (260) or motion-compensated prediction (i.e., inter prediction) (275). In-loop filters (265) are applied to the reconstructed image. The filtered image is stored at a reference picture buffer (280). The decoded picture can further go through post-decoding processing (285), for example, an inverse color transform (e.g. conversion from YCbCr 4:2:0 to RGB 4:4:4) or an inverse remapping performing the inverse of the remapping process performed in the pre-encoding processing (101). The post-decoding processing can use metadata derived in the pre-encoding processing and signaled in the bitstream.

FIG. 11 illustrates a block diagram of an example of a system in which various aspects and embodiments are implemented. System 2000 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 2000, singly or in combination, can be embodied in a single integrated circuit (IC), multiple ICs, and/or discrete components. For example, in at least one embodiment, the processing and encoder/decoder elements of system 2000 are distributed across multiple ICs and/or discrete components. In various embodiments, the system 2000 is communicatively coupled to one or more other systems, or other electronic devices, via, for example, a communications bus or through dedicated input and/or output ports. In various embodiments, the system 2000 is configured to implement one or more of the aspects described in this document.

The system 2000 includes at least one processor 2010 configured to execute instructions loaded therein for implementing, for example, the various aspects described in this document. Processor 2010 can include embedded memory, input output interface, and various other circuitries as known in the art. The system 2000 includes at least one memory 2020 (e.g., a volatile memory device, and/or a non-volatile memory device). System 2000 includes a storage device 2040, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 2040 can include an internal storage device, an attached storage device (including detachable and non-detachable storage devices), and/or a network accessible storage device, as non-limiting examples.

System 2000 includes an encoder/decoder module 2030 configured, for example, to process data to provide an encoded video or decoded video, and the encoder/decoder module 2030 can include its own processor and memory. The encoder/decoder module 2030 represents module(s) that can be included in a device to perform the encoding and/or decoding functions. As is known, a device can include one or both of the encoding and decoding modules. Additionally, encoder/decoder module 2030 can be implemented as a separate element of system 2000 or can be incorporated within processor 2010 as a combination of hardware and software as known to those skilled in the art.

Program code to be loaded onto processor 2010 or encoder/decoder 2030 to perform the various aspects described in this document can be stored in storage device 2040 and subsequently loaded onto memory 2020 for execution by processor 2010. In accordance with various embodiments, one or more of processor 2010, memory 2020, storage device 2040, and encoder/decoder module 2030 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 2010 and/or the encoder/decoder module 2030 is used to store instructions and to provide working memory for processing that is needed during encoding or decoding. In other embodiments, however, a memory external to the processing device (for example, the processing device can be either the processor 2010 or the encoder/decoder module 2030) is used for one or more of these functions. The external memory can be the memory 2020 and/or the storage device 2040, for example, a dynamic volatile memory and/or a non-volatile flash memory. In several embodiments, an external non-volatile flash memory is used to store the operating system of, for example, a television.

In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 2000 can be provided through various input devices as indicated in block 2005. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 11, include composite video.

In various embodiments, the input devices of block 2005 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 2000 to other electronic devices across USB and/or HDMI connections. It is to be understood that various aspects of input processing, for example, Reed-Solomon error correction, can be implemented, for example, within a separate input processing IC or within processor 2010 as necessary. Similarly, aspects of USB or HDMI interface processing can be implemented within separate interface ICs or within processor 2010 as necessary. The demodulated, error corrected, and demultiplexed stream is provided to various processing elements, including, for example, processor 2010, and encoder/decoder 2030 operating in combination with the memory and storage elements to process the data stream as necessary for presentation on an output device.

Various elements of system 2000 can be provided within an integrated housing, Within the integrated housing, the various elements can be interconnected and transmit data therebetween using suitable connection arrangement 2015, for example, an internal bus as known in the art, including the Inter-IC (I2C) bus, wiring, and printed circuit boards. The system 2000 includes communication interface 2050 that enables communication with other devices via communication channel 2090. The communication interface 2050 can include, but is not limited to, a transceiver configured to transmit and to receive data over communication channel 2090. The communication interface 2050 can include, but is not limited to, a modem or network card and the communication channel 2090 can be implemented, for example, within a wired and/or a wireless medium.

Data is streamed, or otherwise provided, to the system 2000, in various embodiments, using a wireless network such as a Wi-Fi network, for example IEEE 802.11 (IEEE refers to the Institute of Electrical and Electronics Engineers). The Wi-Fi signal of these embodiments is received over the communications channel 2090 and the communications interface 2050 which are adapted for Wi-Fi communications. The communications channel 2090 of these embodiments is typically connected to an access point or router that provides access to external networks including the Internet for allowing streaming applications and other over-the-top communications. Other embodiments provide streamed data to the system 2000 using a set-top box that delivers the data over the HDMI connection of the input block 2005. Still other embodiments provide streamed data to the system 2000 using the RF connection of the input block 2005. As indicated above, various embodiments provide data in a non-streaming manner. Additionally, various embodiments use wireless networks other than Wi-Fi, for example a cellular network or a Bluetooth network.

The system 2000 can provide an output signal to various output devices, including a display 2065, speakers 2075, and other peripheral devices 2085. The display 2065 of various embodiments includes one or more of, for example, a touchscreen display, an organic light-emitting diode (OLED) display, a curved display, and/or a foldable display. The display 2065 can be for a television, a tablet, a laptop, a cell phone (mobile phone), or other device. The display 2065 can also be integrated with other components (for example, as in a smart phone), or separate (for example, an external monitor for a laptop). The other peripheral devices 2085 include, in various examples of embodiments, one or more of a stand-alone digital video disc (or digital versatile disc) (DVR, for both terms), a disk player, a stereo system, and/or a lighting system. Various embodiments use one or more peripheral devices 2085 that provide a function based on the output of the system 2000. For example, a disk player performs the function of playing the output of the system 2000.

In various embodiments, control signals are communicated between the system 2000 and the display 2065, speakers 2075, or other peripheral devices 2085 using signaling such as AV.Link, Consumer Electronics Control (CEC), or other communications protocols that enable device-to-device control with or without user intervention. The output devices can be communicatively coupled to system 2000 via dedicated connections through respective interfaces 2065, 2075, and 2085. Alternatively, the output devices can be connected to system 2000 using the communications channel 2090 via the communications interface 2050. The display 2065 and speakers 2075 can be integrated in a single unit with the other components of system 2000 in an electronic device such as, for example, a television. In various embodiments, the display interface 2065 includes a display driver, such as, for example, a timing controller (T Con) chip.

The display 2065 and speaker 2075 can alternatively be separate from one or more of the other components, for example, if the RF portion of input 2005 is part of a separate set-top box. In various embodiments in which the display 2065 and speakers 2075 are external components, the output signal can be provided via dedicated output connections, including, for example, HDMI ports, USB ports, or COMP outputs.

The embodiments can be carried out by computer software implemented by the processor 2010 or by hardware, or by a combination of hardware and software. As a non-limiting example, the embodiments can be implemented by one or more integrated circuits. The memory 2020 can be of any type appropriate to the technical environment and can be implemented using any appropriate data storage technology, such as optical memory devices, magnetic memory devices, semiconductor-based memory devices, fixed memory, and removable memory, as non-limiting examples. The processor 2010 can be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, comprising determining an intra prediction mode with wide angular prediction adapted to a non-dyadic block and decoding the non-dyadic block using intra prediction mode.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, determining an intra prediction mode with wide angular prediction adapted to a non-dyadic block and encoding the non-dyadic block using intra prediction mode.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art. Note that the syntax elements as used herein, for example, intraPredAngle are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem.

For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of parameters for transform. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
Adapting intra prediction mode to a width or height of a block not being a power of two, called non-dyadic block, in the decoder and/or encoder.
Obtaining a non-dyadic block of height H=rh and width W=w where h and w are power of two and where r is not a power of two.
Obtaining a non-dyadic block of height H=h and the width W=rw where h and w are power of two and where r is not a power of two.
Obtaining a non-dyadic block of height H=h and the width W=3w/4 where h and w are power of two.
Obtaining a non-dyadic block of height H=h/3 and width W=w where h and w are power of two.
Adapting intra prediction mode wherein only regular angular intra prediction modes are allowed and a reference array used in intra prediction is extended to a size equal to H+W+1.
Adapting intra prediction mode wherein two only wide angular intra prediction modes are allowed and a reference array used in intra prediction is extended to a size equal to 2H+p or 2W+p where p=1, 2 or 4 depending of the width W and the height H of the image block.
Adapting intra prediction mode wherein an angle value of at least one regular angular intra prediction modes are modified and a reference array used in intra prediction is 2H+1 or 2W+1.
Adapting intra sub-partition mode to a width or height of a block not being a power of two, called non-dyadic block, in the decoder and/or encoder.
Obtaining a non-dyadic block of height h=rH and width w=W where H and W are power of two and where r is a rational different from a power of two.
Obtaining a non-dyadic block of height h=H and the width w=rW where H and W are power of two and where r is a rational different from a power of two.
Obtaining a non-dyadic block of height h=rH and width w=W where H and W are power of two and where r is a rational lower than 1 and of the form r=kᵣ/2ⁿ^{ᵣ}, where kᵣ and nᵣare strictly positive integers, such that 2ᵣⁿ≤H and kᵣ is not a multiple of 2.
Obtaining a non-dyadic block of height h=H and the width w=rW where H and W are power of two and where and where r is a rational lower than 1 and of the form r=kᵣ/2ⁿ^{ᵣ}, where ky and nr are strictly positive integers, such that 2ᵣⁿ≤W and kᵣ is not a multiple of 2. Obtaining a non-dyadic block of height h=H and the width w=3W/4 where H and W are power of two.
Obtaining a non-dyadic block of height h=3H/4 and width w=W where H and W are power of two.
Adapting intra sub partition mode wherein a horizontal intra sub-partition mode results into three sub-partitions of size W×H/4 for an image block of size W×3H/4 or wherein a horizontal intra sub-partition mode results into four sub-partitions of size 3W/4×H/4 for an image block of size 3W/4×H.
Adapting intra sub partition mode wherein a vertical intra sub-partition mode results into four sub-partitions of size W/4×3H/4 for an image block of size W×3H/4 or wherein a vertical intra sub-partition mode results into three sub-partitions of size W/4×H for an image block of size 3W/4×H.
Adapting intra sub partition mode wherein a horizontal intra sub-partition mode results into p sub-partitions of size

$$W \times \frac{r}{p} H$$

for an image block or size W×rH with r rational such that r%p=0 and the transform size p is supported, or wherein a horizontal intra sub-partition mode results into four sub-partitions of size rW×H/4 for an image block of size rW×H.
Adapting intra sub partition mode wherein a horizontal intra sub-partition mode results into kᵣ sub-partitions of size W×H/2ⁿ^{ᵣ} for an image block of size

$$W \times \frac{{k}_{r}}{{2}^{{n}_{r}}} H$$

or wherein a horizontal intra sub-partition mode results into four sub-partitions of size

$$\frac{{k}_{r}}{{2}^{{n}_{r}}} W \times H / 4$$

for an image block of size

$$\frac{{k}_{r}}{{2}^{{n}_{r}}} W \times H .$$

Adapting intra sub partition mode wherein a vertical intra sub-partition mode results into p sub-partitions of size

$$\frac{r}{p} W \times H$$

for an image block of size rW×H with r rational such that r%p=0 and the transform size p is supported, or wherein a vertical intra sub-partition mode results into four sub-partitions of size W/4×rH for an image block of size W×rH.
Adapting intra sub partition mode wherein a vertical intra sub-partition mode results into kᵣ sub-partitions of size 2ᵣⁿ≤H for an image block of size a vertical intra sub-partition mode results into four sub-partitions of size for

$$\frac{{k}_{r}}{{2}^{{n}_{r}}} W \times H$$

for

$$W / 4 \times \frac{{k}_{r}}{{2}^{{n}_{r}}} H$$

an image block of size

$$W \times \frac{{k}_{r}}{{2}^{{n}_{r}}} H .$$

Adapting intra sub partition mode wherein a horizontal-up intra sub-partition mode results into two sub-partitions of size W×H/4 for the upper intra sub-partition and W×H/2 for the lower intra sub-partition for an image block of size W×3H/4 or a horizontal-down intra sub-partition mode results into two sub-partitions of size W×H/2 for the upper intra sub-partition and W×3H/4 for the lower intra sub-partition for an image block of size W×3H/4.
Adapting intra sub partition mode wherein one of a horizontal-up intra sub-partition mode resulting into two sub-partitions of size W×H/4 for the upper intra sub-partition and W×H/2 for the lower intra sub-partition or a horizontal-down intra sub-partition mode resulting into two sub-partitions of size W×H/2 for the upper intra sub-partition and W×3H/4 for the lower intra sub-partition is always used for an image block of size W×3H/4.
Adapting intra sub partition mode wherein a vertical-left intra sub-partition mode results into two sub-partitions of size of size W/4×H for the left intra sub-partition and W/4×H for the right intra sub-partition for an image block of size 3W/4×H or a vertical-right intra sub-partition mode results into two sub-partitions of size of size W/2×H for the left intra sub-partition and W/4×H for the right intra sub-partition for an image block of size 3W/4×H.
Adapting intra sub partition mode wherein one of a vertical-left intra sub-partition mode resulting into two sub-partitions of size of size W/4×H for the left intra sub-partition and W/4×H for the right intra sub-partition or a vertical-right intra sub-partition mode resulting into two sub-partitions of size of size W/2×H for the left intra sub-partition and W/4×H for the right intra sub-partition is always used for an image block of size 3W/4×H.
Selecting a variant for adapting intra prediction mode to non-dyadic block to apply in the decoder and/or encoder.
Signaling an information relative to a variant of an adapting process of an intra prediction mode to non-dyadic block to apply in the decoder.
Deriving an information relative to a variant of an adapting process of an intra prediction mode to non-dyadic block to apply from the availability of neighboring pixels, the deriving being applied in the decoder and/or encoder.
Inserting in the signaling syntax elements that enable the decoder to identify the adapting process process to use, such as intra prediction mode for non-dyadic block.
Selecting, based on these syntax elements, the at least one adapting process to apply at the decoder.
A bitstream or signal that includes one or more of the described syntax elements, or variations thereof.
A bitstream or signal that includes syntax conveying information generated according to any of the embodiments described.
Inserting in the signaling syntax elements that enable the decoder to enable an intra prediction mode to apply for non-dyadic block in a manner corresponding to that used by an encoder.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.
A TV, set-top box, cell phone, tablet, or other electronic device that performs an intra prediction process adapted to non-dyadic block according to any of the embodiments described.
A TV, set-top box, cell phone, tablet, or other electronic device that performs an intra prediction process adapted to non-dyadic block according to any of the embodiments described, and that displays (e.g. using a monitor, screen, or other type of display) a resulting image.
A TV, set-top box, cell phone, tablet, or other electronic device that selects (e.g. using a tuner) a channel to receive a signal including an encoded image, and performs a an intra prediction process adapted to non-dyadic block according to any of the embodiments described.
A TV, set-top box, cell phone, tablet, or other electronic device that receives (e.g. using an antenna) a signal over the air that includes an encoded image, and performs an intra prediction process adapted to non-dyadic block according to any of the embodiments described.

1-58. (canceled)

59. A method comprising decoding an image block, the decoding further comprising:
determining that a width of the image block is W=w and a height of the image block is H=3w/4 or that a width of the image block is W=3h/4 and a height of the image block is H=h where h and w are power of two;
determining a wide angular intra prediction mode for the image block among two allowed wide angular intra prediction modes;
determining a reference array used in intra prediction of size equal to 2H+p or 2W+p where p=1, 2 or 4 depending on the width and the height of the image block; and
decoding the image block using the determined wide angular intra prediction mode and the determined reference array.

60. The method of claim 59, wherein the wide angular intra prediction mode allows an intra prediction angle value beyond a range of 180 degree from 45 degree to −135 degree.

61. The method of claim 59 further comprising:
decoding at least one syntax data element related to enabling the wide angular intra prediction mode from one of a slice header, a picture parameter set, and a sequence parameter set.

62. A non-transitory program storage device, readable by a computer, tangibly embodying a program of instructions executable by the computer for performing the method according to claim 59.

63. An apparatus comprising a memory and one or more processors, wherein the one or more processors are configured to:
access an image block;
determine that a width of the image block is W=w and a height of the image block is H=3w/4 or that a width of the image block is W=3h/4 and a height of the image block is H=h where h and w are power of two;
determine a wide angular intra prediction mode for the image block among two allowed wide angular intra prediction modes;
determine a reference array used in intra prediction of size equal to 2H+p or 2W+p where p=1, 2 or 4 depending on the width and the height of the image block; and
decode the image block using the determined wide angular intra prediction mode and the determined reference array.

64. The apparatus of claim 63, wherein the wide angular intra prediction mode allows an intra prediction angle value beyond a range of 180 degree from 45 degree to −135 degree.

65. The apparatus of claim 63, wherein the one or more processors are configured to:
decode at least one syntax data element related to enabling the wide angular intra prediction mode from one of a slice header, a picture parameter set, and a sequence parameter set.

66. A method comprising encoding an image block, the encoding further comprising:
determining that a width of the image block is W=w and a height of the image block is H=3w/4 or that a width of the image block is W=3h/4 and a height of the image block is H=h where h and w are power of two;
determining a wide angular intra prediction mode for the image block among two allowed wide angular intra prediction modes;
determining a reference array used in intra prediction of size equal to 2H+p or 2W+p where p=1, 2 or 4 depending on the width and the height of the image block; and
decoding the image block using the determined wide angular intra prediction mode and the determined reference array.

67. The method of claim 66, wherein the wide angular intra prediction mode allows an intra prediction angle value beyond a range of 180 degree from 45 degree to −135 degree.

68. The method of claim 66 further comprising:
encoding at least one syntax data element related to enabling the wide angular intra prediction mode in one of a slice header, a picture parameter set, and a sequence parameter set.

69. A non-transitory program storage device, readable by a computer, tangibly embodying a program of instructions executable by the computer for performing the method according to claim 66.

70. A non-transitory program storage device having encoded data representative of an image block generated according to a method 68.

71. An apparatus comprising a memory and one or more processors, wherein the one or more processors are configured to:
access an image block;
determine that a width of the image block is W=w and a height of the image block is H=3w/4 or that a width of the image block is W=3h/4 and a height of the image block is H=h where h and w are power of two;
determine a wide angular intra prediction mode for the image block among two allowed wide angular intra prediction modes;
determine a reference array used in intra prediction of size equal to 2H+p or 2W+p where p=1, 2 or 4 depending on the width and the height of the image block; and
encode the image block using the determined wide angular intra prediction mode and the determined reference array.

72. The apparatus of claim 71, wherein the wide angular intra prediction mode allows an intra prediction angle value beyond a range of 180 degree from 45 degree to −135 degree.

73. The apparatus of claim 71, wherein the one or more processors are configured to:
encode at least one syntax data element related to enabling the wide angular intra prediction mode from one of a slice header, a picture parameter set, and a sequence parameter set.
